(19) United States
(12) Patent Application Publication
(10) Pub. No.: US 2023/0133103 A1
(43) Pub. Date: May 4, 2023

(54) LEARNING MODEL GENERATION METHOD, IMAGE PROCESSING APPARATUS, PROGRAM, AND TRAINING DATA GENERATION METHOD

(71) Applicant: TERUMO KABUSHIKI KAISHA, Tokyo (JP)

(72) Inventors: Shunsuke YOSHIZAWA, Ebina-shi (JP); Yasukazu SAKAMOTO, Hiratsuka-shi (JP); Katsuhiko SHIMIZU, Fujinomiya-shi (JP); Hiroyuki ISHIHARA, Tokyo (JP)

(73) Assignee: TERUMO KABUSHIKI KAISHA, Tokyo (JP)

(21) Appl. No.: 17/974,893

(22) Filed: Oct. 27, 2022

(30) Foreign Application Priority Data
Oct. 28, 2021 (JP) 2021-176886

(51) Int. Cl. G06V 10/774; G06V 10/25; G06T 7/00

(52) U.S. Cl. CPC G06V 10/774; G06V 10/25; G06T 7/0014; G06V 2201/03; G06T 2207/10072

(57) ABSTRACT

A learning model generation method includes: acquiring training data from a training database that records a plurality of sets of a tomographic image acquired using a tomographic image acquisition probe, and correct answer classification data in which each of pixels included in the tomographic image is classified into a plurality of regions including a living tissue region and a non-living tissue region, in association with each other; acquiring thin-walled part data relating to a thin-walled part thinner than a predetermined threshold value, for a predetermined region in the correct answer classification data; and performing a parameter adjustment process for a learning model that outputs output classification data in which each of the pixels included in the tomographic image is classified into the plurality of regions, based on the training data and the thin-walled part data.

### CROSS-REFERENCES TO RELATED APPLICATIONS

This application is based on and claims priority under 35 U.S.C. § 119 to Japanese Patent Application No. 2021-176886 filed on Oct. 28, 2021, the entire content of which is incorporated herein by reference.

### TECHNOLOGICAL FIELD

The present invention generally relates to a learning model generation method, an image processing apparatus, a program, and a training data generation method.

### BACKGROUND DISCUSSION

A catheter system that acquires an image by inserting an image acquisition catheter into a lumen organ such as a blood vessel has been used (WO 2017/164071 A). An ultrasound diagnostic apparatus that displays a segmentation image in which tissues drawn in an image are classified has been proposed (WO 2020/203873 A).

### SUMMARY

By using a segmentation image created based on an image captured using a catheter system, for example, automatic measurement of the area, the volume, or the like, and display of a three-dimensional image are enabled.

However, in a known segmentation approach, there is a case where it is difficult to accurately classify a region drawn thinly in an image.

In one aspect, a learning model generation method and the like disclosed here generate a learning model configured to accurately classify a thinly drawn region.

A learning model generation method includes: acquiring training data from a training database that records a plurality of sets of a tomographic image acquired using a tomographic image acquisition probe, and correct answer classification data in which the tomographic image is classified into a plurality of regions including a living tissue region and a non-living tissue region, in association with each other; acquiring thin-walled part data relating to a thin-walled part thinner than a predetermined threshold value, for a predetermined region in the correct answer classification data; and performing a parameter adjustment process for a learning model, based on the training data and the thin-walled part data.

In one aspect, a learning model generation method and the like that generates a learning model configured to accurately classify a thinly drawn region can be provided.

### BRIEF DESCRIPTION OF THE DRAWINGS

FIG. 1 is an explanatory diagram explaining a generation method for a classification model;

FIG. 2 is an explanatory diagram explaining a configuration of an information processing apparatus;

FIG. 3 is an explanatory diagram explaining a record layout of a classification training database (DB);

FIG. 4 is an explanatory diagram explaining thin-walled part data;

FIG. 5 is an explanatory diagram explaining the thin-walled part data;

FIG. 6 is an explanatory diagram explaining the thin-walled part data;

FIG. 7 is an explanatory diagram explaining difference data;

FIG. 8 is an explanatory diagram explaining weighted difference data;

FIG. 9 is a flowchart explaining a processing flow of a program;

FIG. 10 is a flowchart explaining a processing flow of a subroutine for thin-walled part data generation;

FIG. 11 is an explanatory diagram explaining a modification of the difference data;

FIG. 12 is an explanatory diagram explaining a modification of the difference data;

FIG. 13 is an explanatory diagram explaining a modification of the weighted difference data;

FIG. 14 is an explanatory diagram explaining a modification of the weighted difference data;

FIG. 15 is an explanatory diagram explaining a modification of the thin-walled part data;

FIG. 16 is an explanatory diagram explaining a thin-walled part extraction model;

FIG. 17 is an explanatory diagram explaining a record layout of a thin-walled part training DB;

FIG. 18 is an explanatory diagram explaining a generation method for the classification model according to a modification 1-8;

FIG. 19 is an explanatory diagram explaining a generation method for a classification model according to a second embodiment;

FIG. 20 is an explanatory diagram explaining the generation method for the classification model according to the second embodiment;

FIG. 21 is an explanatory diagram explaining the generation method for the classification model according to the second embodiment;

FIG. 22 is an explanatory diagram explaining the generation method for the classification model according to the second embodiment;

FIG. 23 is an explanatory diagram explaining weighted correct answer classification data according to a modification 2-1;

FIG. 24 is an explanatory diagram explaining a loss value according to a third embodiment;

FIG. 25 is an explanatory diagram explaining the loss value according to the third embodiment;

FIG. 26 is a flowchart explaining a processing flow of a program according to the third embodiment;

FIG. 27 is a flowchart explaining a processing flow of a subroutine for loss value calculation;

FIG. 28 is an explanatory diagram explaining difference data according to a fourth embodiment;

FIG. 29 is a flowchart explaining a processing flow of a program according to a fifth embodiment;

FIG. 30 is an explanatory diagram explaining a configuration of a catheter system according to a sixth embodiment;

FIG. 31 is a flowchart explaining a processing flow of a program according to the sixth embodiment;

FIG. 32 is an explanatory diagram explaining a configuration of an information processing apparatus according to a seventh embodiment;

FIG. 33 is a functional block diagram of an information processing apparatus according to an eighth embodiment; and

FIG. 34 is a functional block diagram of an image processing apparatus according to a ninth embodiment.

### DETAILED DESCRIPTION

### First Embodiment

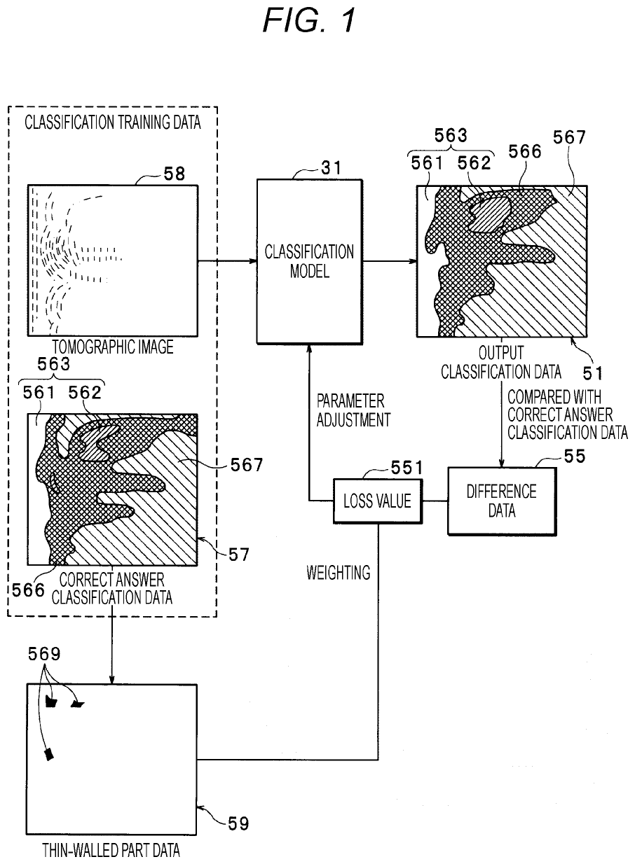

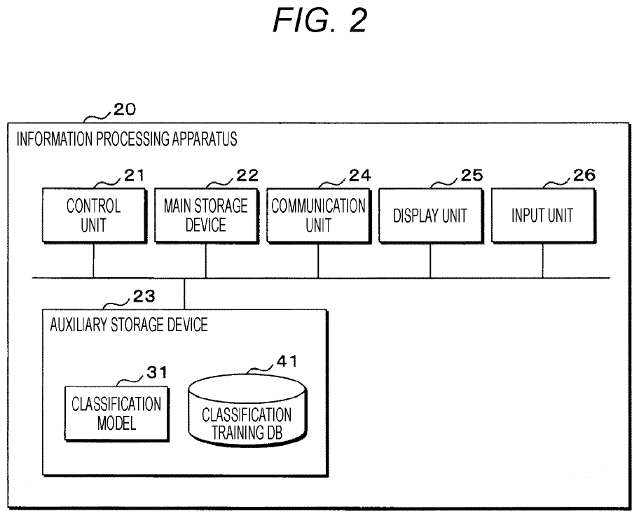

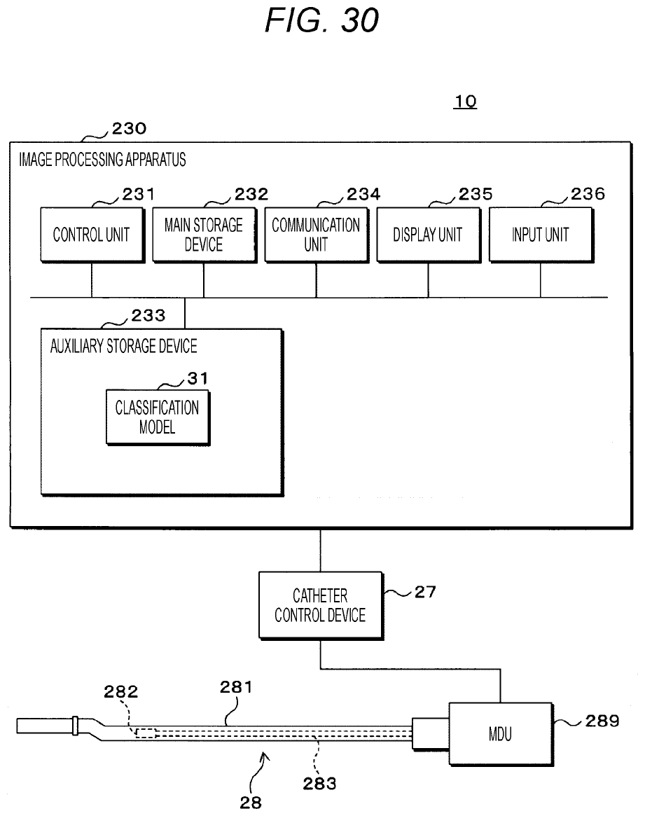

FIG. 1 is an explanatory diagram explaining a generation method for a classification model 31. A large number of pieces of classification training data in which a tomographic image 58 and correct answer classification data 57 are combined as a set are recorded in a classification training database (DB) 41 (see FIG. 2). In the present embodiment, a case where the tomographic image 58 is an ultrasound tomographic image captured using an image acquisition catheter 28 (see FIG. 30) for intravascular ultrasound (IVUS) will be described as an example. The image acquisition catheter 28 is an example of a tomographic image acquisition probe that acquires the tomographic image 58 of the body of a patient.

The tomographic image 58 may be a tomographic image 58 by optical coherence tomography (OCT) using near-infrared light. The tomographic image 58 may be an ultrasound tomographic image acquired using the linear scanning or sector scanning image acquisition catheter 28. The tomographic image 58 may be an ultrasound tomographic image acquired using a transesophageal echocardiography (TEE) probe. The tomographic image 58 may be an ultrasound tomographic image acquired using an extracorporeal ultrasound probe that is applied to the body surface of the patient.

FIG. 1 illustrates the tomographic image 58 in a so-called RT format formed by arranging scanning line data in parallel in the order of the scanning angle. The left end of the tomographic image 58 represents the image acquisition catheter 28. A horizontal direction of the tomographic image 58 corresponds to the distance to the image acquisition catheter 28, and a vertical direction of the tomographic image 58 corresponds to the scanning angle.

The correct answer classification data 57 is data obtained by classifying each pixel included in the tomographic image 58 into a living tissue region 566, a lumen region 563, and an extraluminal region 567. The lumen region 563 is a region circumferentially surrounded by the living tissue region 566. The lumen region 563 is classified into a first lumen region 561 into which the image acquisition catheter 28 is inserted and a second lumen region 562 into which the image acquisition catheter 28 is not inserted. In the following description, each piece of data constituting the correct answer classification data 57 is also described as a “pixel” similarly to the data included in the tomographic image 58.

Each pixel is associated with a label indicating the region into which the pixel is classified. In FIG. 1, a portion associated with the label of the living tissue region 566 is indicated by grid hatching, a portion associated with the label of the first lumen region 561 is indicated by no hatching, a portion associated with the label of the second lumen region 562 is indicated by left-downward hatching, and a portion associated with the label of the extraluminal region 567 is indicated by right-downward hatching. Note that the labels may be associated with each small region obtained by collecting a plurality of pixels included in the tomographic image 58.

A case where the image acquisition catheter 28 is inserted into a circulatory organ such as a blood vessel or a heart will be specifically described as an example. The living tissue region 566 corresponds to a lumen organ wall, such as a blood vessel wall or a heart wall. The first lumen region 561 is a region inside the lumen organ into which the image acquisition catheter 28 is inserted. That is, the first lumen region 561 is a region filled with blood.

The second lumen region 562 is a region inside another lumen organ located in the vicinity of the blood vessel or the like into which the image acquisition catheter 28 is inserted. For example, the second lumen region 562 is a region inside a blood vessel branched from the blood vessel into which the image acquisition catheter 28 is inserted or a region inside another blood vessel close to the blood vessel into which the image acquisition catheter 28 is inserted. There is also a case where the second lumen region 562 is a region inside a lumen organ other than the circulatory organ, such as a bile duct, a pancreatic duct, a ureter, or a urethra as an example.

The extraluminal region 567 is a region outside the living tissue region 566. When the living tissue region 566 on a distal side of the image acquisition catheter 28 is not accommodated within the display range of the tomographic image 58 even in a region inside an atrium, a ventricle, a thick blood vessel, or the like, the living tissue region 566 is classified into the extraluminal region 567.

Although not illustrated, the correct answer classification data 57 may include labels corresponding to a variety of regions such as an instrument region in which the image acquisition catheter 28 and a guide wire and the like inserted together with the image acquisition catheter 28 are drawn, and a lesion region in which a lesion such as calcification is drawn, as an example.

The correct answer classification data 57 may be data in which both of the first lumen region 561 and the second lumen region 562 are classified into the lumen region 563 without being distinguished from each other. The correct answer classification data 57 may be data classified into two types of regions, namely, the living tissue region 566 and a non-living tissue region.

The correct answer classification data 57 is created by an expert such as a medical doctor or a clinical examination technician who is proficient in interpreting the tomographic image 58, or a trained operator and is recorded in the classification training DB 41 in association with the tomographic image 58.

Thin-walled part data 59 obtained by extracting a thin-walled part region 569 thinner than a predetermined threshold value for a specified region is generated from the correct answer classification data 57. FIG. 1 illustrates an example of a case where the thin-walled part regions 569 are portions where the living tissue region 566 is thinner than a predetermined threshold value. Details of the extraction method for the thin-walled part region 569 will be described later.

Machine learning of the classification model 31 that outputs output classification data 51 when the tomographic image 58 is input is performed using the classification training DB 41. Here, the classification model 31 is, for example, a model having a U-Net structure that implements semantic segmentation. The classification model 31 is an example of a learning model of the present embodiment.

The U-Net structure includes a multi-layer encoder layer and a multi-layer decoder layer connected behind the encoder layer. Each encoder layer includes a pooling layer and a convolution layer. The output classification data 51 in which each pixel constituting the input tomographic image 58 is labeled is generated by semantic segmentation. In the following description, each piece of data constituting the output classification data 51 is also described as a “pixel” similarly to the data included in the tomographic image 58. Note that the classification model 31 may be a mask region-based convolutional neural network (Mask R-CNN) model or any other model that implements segmentation of an image.

An outline of a machine learning method will be described. One set of classification training data is acquired from the classification training DB 41. The tomographic image 58 is input to the classification model 31 in the middle of learning, and the output classification data 51 is output. Difference data 55 is generated based on the comparison between the output classification data 51 and the correct answer classification data 57.

The difference data 55 is data relating to the difference between the label of each pixel constituting the correct answer classification data 57 and the label of the corresponding pixel in the output classification data 51. The output classification data 51, the correct answer classification data 57, and the difference data 55 have the same number of pieces of data. In the following description, each piece of data constituting the difference data 55 is also described as a pixel.

A loss value 551, which is a calculated value relating to the difference between the correct answer classification data 57 and the output classification data 51, is defined based on the difference data 55 weighted using the thin-walled part data 59. Parameter adjustment for the classification model 31 is performed using, for example, the back propagation method such that the loss value 551 approaches a predetermined value. The predetermined value is a small value such as “0” or “0.1”.

Details of the creation of the difference data 55, the weighting by the thin-walled part data 59, and the calculation of the loss value 551 will be described later. By machine learning in which parameter adjustment is repeated using a large number of pieces of the classification training data, the classification model 31 configured to accurately classify even a portion corresponding to the thin-walled part region 569 is generated.

FIG. 2 is an explanatory diagram explaining a configuration of an information processing apparatus 20. The information processing apparatus 20 includes a control unit 21, a main storage device 22, an auxiliary storage device 23, a communication unit 24, a display unit 25, an input unit 26, and a bus. The control unit 21 is an arithmetic control device that executes a program of the present embodiment. For the control unit 21, one or a plurality of central processing units (CPUs) or graphics processing units (GPUs), a multi-core CPU, or the like is used. The control unit 21 is connected to each hardware unit constituting the information processing apparatus 20 via the bus.

The main storage device 22 is a storage device such as a static random access memory (SRAM), a dynamic random access memory (DRAM), or a flash memory. In the main storage device 22, information involved in the middle of the process performed by the control unit 21 and the program being executed by the control unit 21 are temporarily saved.

The auxiliary storage device 23 is a storage device such as an SRAM, a flash memory, a hard disk, or a magnetic tape. In the auxiliary storage device 23, the classification model 31, the classification training DB 41, a program to be executed by the control unit 21, and various sorts of data involved in executing the program are saved. The classification model 31 and the classification training DB 41 may be stored in an external mass storage device or the like connected to the information processing apparatus 20.

The communication unit 24 is an interface that performs communication between the information processing apparatus 20 and a network. For example, the display unit 25 is a liquid crystal display panel, an organic electro luminescence (EL) panel, or the like. For example, the input unit 26 is a keyboard, a mouse, or the like. The input unit 26 may be stacked on the display unit 25 to constitute a touch panel. The display unit 25 may be a display device connected to the information processing apparatus 20. The information processing apparatus 20 may not include the display unit 25 or the input unit 26.

The information processing apparatus 20 is a general-purpose personal computer, a tablet, a large computing machine, or a virtual machine that works on a large computing machine. The information processing apparatus 20 may be constituted by a plurality of personal computers that perform distributed processing, or hardware such as a large computing machine. The information processing apparatus 20 may be constituted by a cloud computing system or a quantum computer.

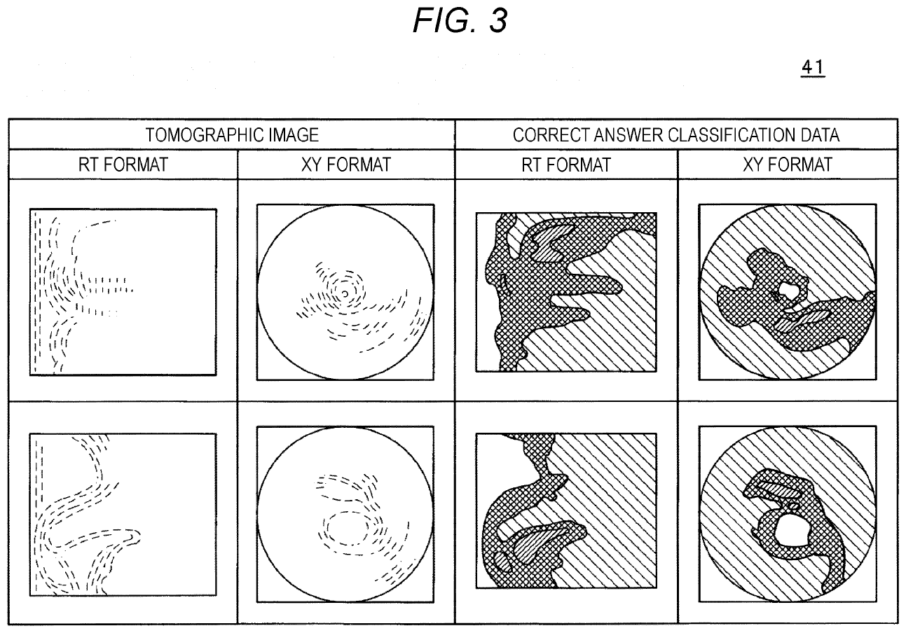

FIG. 3 is an explanatory diagram explaining a record layout of the classification training DB 41. The classification training DB 41 is a database in which a large number of sets of the tomographic image 58 and the correct answer classification data 57 are recorded in association with each other.

The classification training DB 41 includes a tomographic image field and a correct answer classification data field. Each of the tomographic image field and the correct answer classification data field has two subfields, namely, an RT format field and an XY format field.

The RT format field of the tomographic image field records the tomographic image 58 in the RT format formed by arranging scanning line data in parallel in the order of the scanning angle. The XY format field of the tomographic image field records the tomographic image 58 in the XY format generated by conducting coordinate transformation on the tomographic image 58 in the RT format.

The RT format field of the correct answer classification data field records the correct answer classification data 57 in the RT format in which the tomographic image 58 in the RT format is classified into a plurality of regions. The XY format field of the correct answer classification data field records the correct answer classification data 57 in the XY format in which the tomographic image 58 in the XY format is classified into a plurality of regions.

Note that the tomographic image 58 in the XY format may be generated by coordinate transformation from the tomographic image 58 in the RT format if applicable, instead of being recorded in the classification training DB 41. Only one of the correct answer classification data 57 in the RT format and the correct answer classification data 57 in the XY format may be recorded in the classification training DB 41, and the other may be generated by coordinate transformation if applicable. The classification training DB 41 has one record for one set of classification training data. The classification training DB 41 is an example of a training database of the present embodiment.

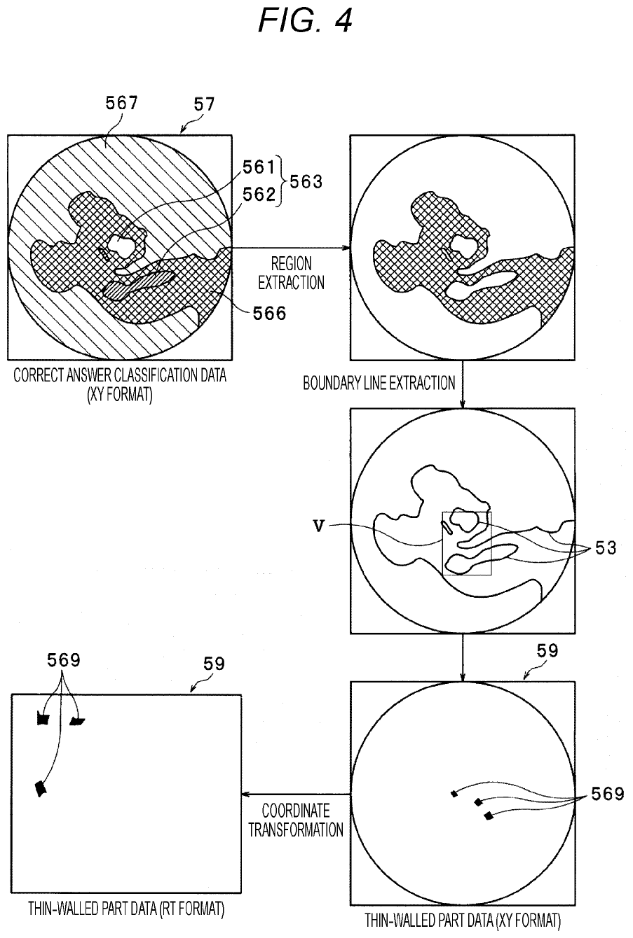

FIGS. 4 to 6 are explanatory diagrams explaining the thin-walled part data 59. In the following description, a case where the control unit 21 extracts the thin-walled part region 569 in which the living tissue region 566 is thin, from the correct answer classification data 57 will be described as an example.

The control unit 21 extracts the living tissue region 566 from the correct answer classification data 57. A state in which the living tissue region 566 is extracted is illustrated in the upper right of FIG. 4. The control unit 21 extracts a boundary line 53 between the living tissue region 566 and regions other than the living tissue region 566, using a known edge extraction algorithm. A state in which the boundary line 53 is extracted is illustrated in the center on the right side of FIG. 4.

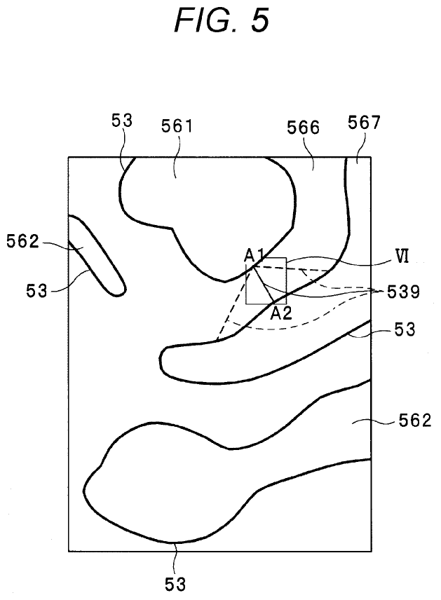

FIG. 5 illustrates an enlarged view of the V portion in FIG. 4. The control unit 21 generates a measurement line 539 that passes only through the living tissue region 566 from an optional point on the boundary line 53 and reaches another point on the boundary line 53. In FIG. 5, a case where the control unit 21 generates the measurement lines 539 that pass only through the living tissue region 566 from the point A1 on the boundary line 53 and reach other points on the boundary line 53 will be described as an example.

The control unit 21 calculates the length of each measurement line 539 and selects the shortest measurement line 539. In FIG. 5, the measurement line 539 connecting the points A1 and A2, which has been selected by the control unit 21, is indicated by a solid line, and the measurement lines 539 not selected by the control unit 21 are indicated by broken lines.

The control unit 21 determines whether the selected measurement line 539 is shorter than a predetermined threshold value. When the selected measurement line 539 is not shorter than the predetermined threshold value, the control unit 21 does not perform the process related to the selected measurement line 539. If the selected measurement line 539 is shorter than the predetermined threshold value, the living tissue region 566 is thinner than a predetermined threshold value in the portion where the measurement line 539 is generated. In the following description, a case where the measurement line 539 connecting the points A1 and A2 is shorter than the threshold value will be described as an example.

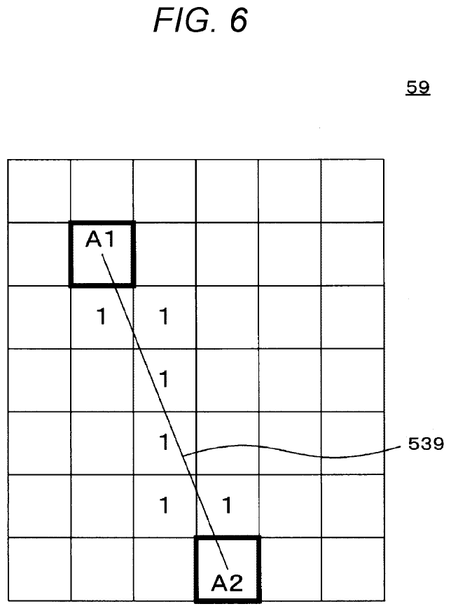

FIG. 6 schematically illustrates an enlarged view of the thin-walled part data 59 corresponding to the VI portion in FIG. 5. The thin-walled part data 59 has the same number of pixels as the correct answer classification data 57. Each frame in FIG. 6 indicates one pixel. The control unit 21 records a thin-walled part flag in the pixel through which the measurement line 539 connecting the points A1 and A2 passes. In the example illustrated in FIG. 6, the thin-walled part flag is “1”. Although not illustrated, a predetermined flag such as “0” is recorded in the pixel in which the thin-walled part flag is not recorded. The control unit 21 records the thin-walled part flag in the pixel through which the measurement line 539 passes, for all the measurement lines 539 satisfying the condition, by the same procedure.

Note that the control unit 21 may receive an input by a user regarding the threshold value for the length of the measurement line 539. The user inputs an appropriate threshold value used for determining whether the region is the thin-walled part region 569, based on the physique of the patient, the disease state, and the like.

Returning to FIG. 4, the description will be continued. In FIG. 6, the portions where the thin-walled part flags are recorded are the thin-walled part regions 569 illustrated in the lower right of FIG. 4. As described with reference to FIGS. 4 to 6, by extracting the thin-walled part region 569 in the XY format and displaying the extracted thin-walled part region 569 on the display unit 25, the user is allowed to confirm whether the control unit 21 has accurately extracted an anatomically thin portion such as a fossa ovalis.

As illustrated in the lower left of FIG. 4, the thin-walled part data 59 in the XY format can be converted into the RT format by coordinate transformation. Note that the control unit 21 may extract the thin-walled part region 569 from the correct answer classification data 57 in the RT format.

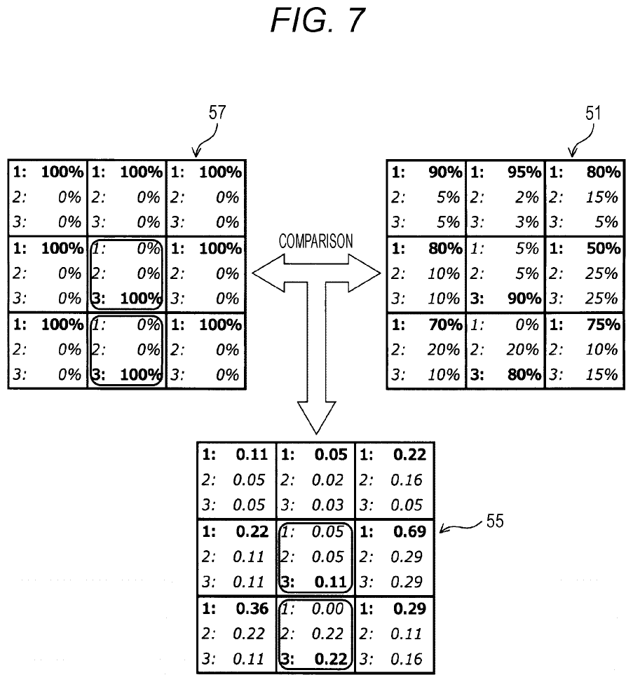

FIG. 7 is an explanatory diagram explaining the difference data 55. The upper left part of FIG. 7 schematically illustrates nine pixels of the correct answer classification data 57. The upper right part of FIG. 7 schematically illustrates nine pixels of the output classification data 51. The lower part of FIG. 7 schematically illustrates nine pixels of the difference data 55. Each group of the nine pixels illustrated in FIG. 7 indicates a group of pixels located at the corresponding place. For the correct answer classification data 57 and the difference data 55, the pixels in the center and the lower center on which the rounded rectangles are displayed are pixels corresponding to the thin-walled part region 569.

Each pixel of the correct answer classification data 57 and the output classification data 51 records a probability for a label into which the relevant pixel is classified. “1” means the label of the first lumen region 561, “2” means the label of the second lumen region 562, and “3” means the label of the living tissue region 566.

Note that the probabilities that the pixel has four or more types of labels or the probabilities that the pixel has two or less types of labels may be recorded for each pixel. For example, in a case where only the classification as to whether or not the pixel falls under the living tissue region 566 is performed, a probability that the pixel has a label indicating “YES” and a probability that the pixel has a label indicating “NO”, or a probability that the pixel has either a label of “YES” or a label of “NO” is recorded for each pixel.

Each pixel of the correct answer classification data 57 is classified into any one of the first lumen region 561, the second lumen region 562, and the living tissue region 566 by an expert. Therefore, the probability for any one of the labels is 100%, and the probabilities for the other labels are 0%. In both of the correct answer classification data 57 and the output classification data 51, the sum of the probabilities for each label is 100% in every pixel.

In the following description, the label classified by an expert for every pixel will be sometimes described as a correct answer label, and other labels will be sometimes described as incorrect answer labels. For example, in the center pixels of the correct answer classification data 57, the output classification data 51, and the difference data 55 in FIG. 7, “1” and “2” represent the incorrect answer labels, and “3” represents the correct answer label. In FIG. 7, the correct answer label is indicated in bold, and the incorrect answer label is indicated in oblique.

Each pixel of the output classification data 51 records the probability of falling under the first lumen region 561, the probability of falling under the second lumen region 562, and the probability of falling under the living tissue region 566. For example, in the output classification data 51 illustrated in FIG. 7, the probability that the pixel in the upper right falls under the first lumen region 561 is 80%, the probability that the pixel falls under the second lumen region 562 is 15%, and the probability that the pixel falls under the living tissue region 566 is 5%. In every pixel, the sum of the probabilities for each label is 100%. The control unit 21 inputs the tomographic image 58 to the classification model 31 and acquires the output classification data 51 output from the classification model 31.

The difference data 55 records losses relating to each label of each pixel. In the following description, each piece of data constituting the difference data 55 is also described as a “pixel” similarly to the data included in the tomographic image 58. The control unit 21 calculates losses relating to each label of each pixel constituting the difference data 55, based on the output classification data 51, the correct answer classification data 57, and formula (1) to generate the difference data 55.

$$\begin{matrix}[ Math . 1 ] & \\ {E}_{ij} = \{ \begin{matrix}- L n ( {Q}_{ij} ) & ( Correct answer label ) \\ - L n ( 1 - {Q}_{ij} ) & ( Incorrect answer label )\end{matrix} & ( 1 )\end{matrix}$$

Eij indicates the loss relating to the j-th label of the i-th pixel.

Ln(x) indicates a natural logarithm of x.

Qij indicates a probability that the i-th pixel has the j-th label in the output classification data.

Note that Qij is a positive value equal to or smaller than one. Formula (1) is an example of a computation formula when the difference data 55 is generated. The calculation formula for losses relating to each label of each pixel is not limited to formula (1). Modifications of the difference data 55 will be described later.

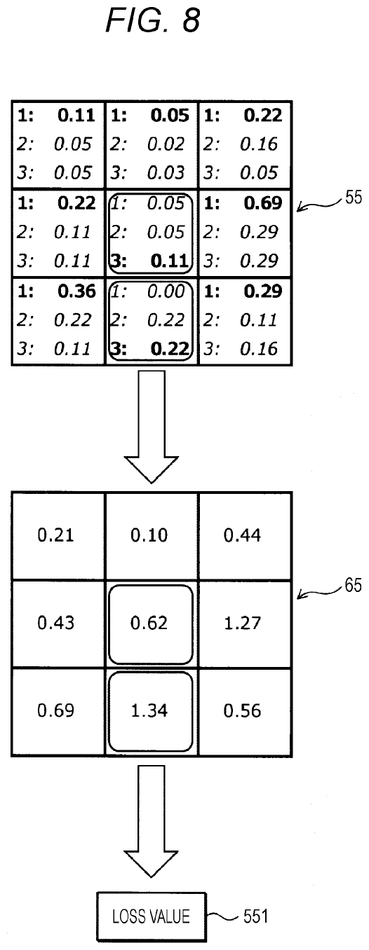

FIG. 8 is an explanatory diagram explaining weighted difference data 65. The weighted difference data 65 is data indicating losses calculated by weighting each pixel of the difference data 55 based on the thin-walled part data 59. In the following description, each piece of data constituting the weighted difference data 65 is also described as a “pixel” similarly to the data included in the tomographic image 58.

The control unit 21 calculates losses relating to each pixel constituting the weighted difference data 65, based on, for example, formula (2). The loss relating to the thin-walled part region 569 is weighted according to formula (2).

$$\begin{matrix}[ Math . 2 ] & \\ F i = {\sum }_{j = 1}^{u} {E}_{ij} {G}_{i} & ( 2 )\end{matrix}$$

Fi indicates the loss of the i-th pixel.

Gi indicates a weight relating to the thin-walled part region.

When the i-th pixel falls under the thin-walled part region, Gi=m holds.

When the i-th pixel does not fall under the thin-walled part region, Gi=1 holds.

m indicates a thin-walled part coefficient that is a constant greater than one.

u denotes the number of regions into which the pixel is classified.

Formula (2) indicates that the loss of each pixel is defined such that the loss of the pixel classified into the thin-walled part region 569 has a weight of m times the loss of the pixel classified into a region other than the thin-walled part region 569. The thin-walled part coefficient m is, for example, three.

The control unit 21 may define the thin-walled part coefficient m in formula (2) based on the thickness of the thin-walled part region 569. For example, the control unit 21 makes the thin-walled part coefficient m for the thin-walled part region 569 thinner than the threshold value greater than the thin-walled part coefficient m for the thin-walled part region 569 having a thickness equal to or greater than the threshold value. The thin-walled part coefficient m may be defined by, for example, a function for the thickness of the thin-walled part region 569.

Note that the weighted loss calculation method is not limited to formula (2). Some modifications will be described later.

The control unit 21 calculates the loss value 551, based on the weighted difference data 65. The loss value 551 is a representative value of losses of the respective pixels constituting the weighted difference data 65. When the arithmetic mean value is used as the representative value, the control unit 21 calculates the loss value 551 based on formula (3).

$$\begin{matrix}[ Math . 3 ] & \\ Loss value = \frac{1}{C} {\sum }_{i = 1}^{C} {F}_{i} & ( 3 )\end{matrix}$$

C indicates the number of pixels.

The representative value used for the loss value 551 may be any representative value such as a geometric mean value, a harmonic mean value, or a sum of squares as an example.

The control unit 21 may define the loss value 551 based on the loss Fi of one or a plurality of pixels. For example, the control unit 21 may calculate the loss value 551 based on a pixel whose distance from the image acquisition catheter 28 is within a predetermined range.

The control unit 21 adjusts the parameters of the classification model 31 using, for example, the back propagation method such that the loss value 551 approaches a predetermined value. By repeating parameter adjustment for the classification model 31 using a large number of pieces of the classification training data, the control unit 21 performs machine learning of the classification model 31 such that the classification model 31 outputs the appropriate output classification data 51 when the tomographic image 58 is input.

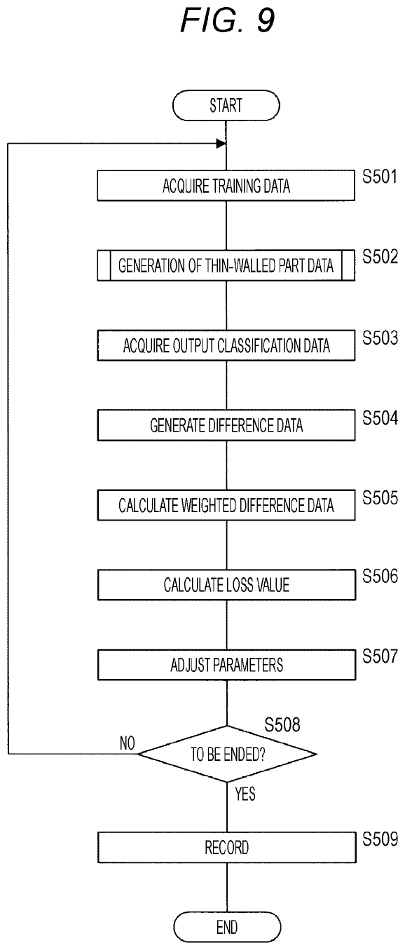

FIG. 9 is a flowchart explaining a processing flow of a program. The control unit 21 acquires one set of classification training data from the classification training DB 41 (step S501). In step S501, the control unit 21 implements the function of a training data acquisition unit of the present embodiments. The control unit 21 activates a subroutine for thin-walled part data generation (step S502). The subroutine for thin-walled part data generation is a subroutine that generates the thin-walled part data 59 based on the correct answer classification data 57. A processing flow of the subroutine for thin-walled part data generation will be described later. In step S502, the control unit 21 implements the function of a thin-walled part data acquisition unit of the present embodiments.

The control unit 21 inputs the tomographic image 58 to the classification model 31 being trained and acquires the output classification data 51 (step S503). Using the correct answer classification data 57 and the output classification data 51, the control unit 21 calculates the difference data 55 based on, for example, formula (1) (step S504). The control unit 21 calculates the weighted difference data 65 based on, for example, formula (2) (step S505).

The control unit 21 calculates the loss value 551 based on, for example, formula (3) (step S506). The control unit 21 performs parameter adjustment for the classification model 31 using, for example, the back propagation method such that the loss value 551 approaches a predetermined value (step S507). In step S507, the control unit 21 implements the function of a parameter adjustment unit of the present embodiments.

The control unit 21 determines whether to end the process (step S508). For example, when a predetermined number of pieces of the classification training data have been learned, the control unit 21 determines to end the process. For example, when the loss value 551 or the amount of adjustment of the parameters falls below a predetermined threshold value, the control unit 21 may determine to end the process.

When determining not to end the process (NO in step S508), the control unit 21 returns to step S501. When determining to end the process (YES in step S508), the control unit 21 records the adjusted parameters of the classification model 31 in the auxiliary storage device 23 (step S509). Thereafter, the control unit 21 ends the process. As described above, the generation of the classification model 31 ends.

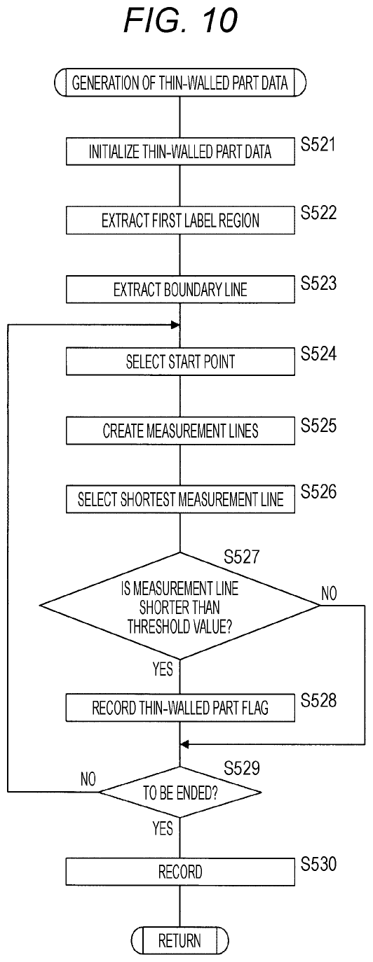

FIG. 10 is a flowchart explaining a processing flow of the subroutine for thin-walled part data generation. The subroutine for thin-walled part data generation is a subroutine that generates the thin-walled part data 59 based on the correct answer classification data 57. The control unit 21 executes the process described with reference to FIGS. 4 to 6 by the subroutine for thin-walled part data generation.

The control unit 21 initializes the thin-walled part data 59 (step S521). Specifically, the control unit 21 sets all the pixels of the thin-walled part data 59 having the same number of pixels as the correct answer classification data 57 to a predetermined initial value. In the following description, a case where the predetermined initial value is “0” will be described as an example.

The control unit 21 creates a copy of the correct answer classification data 57. The control unit 21 performs the process described below on the copy of the correct answer classification data 57. Note that, in the description below, the copy of the correct answer classification data 57 will be sometimes simply described as the correct answer classification data 57.

The control unit 21 extracts a first label region in which a first label is recorded in the pixel, from the correct answer classification data 57 (step S522). Specifically, the control unit 21 records “1” in the pixel in which the label of the first label region is recorded and records “0” in the pixel in which the label of a region other than the first label region is recorded. In the example described with reference to FIG. 1, the first label region is the living tissue region 566. In the upper right diagram of FIG. 4, the pixels in which “1” is recorded are indicated by grid hatching. Note that the first label region is not limited to the living tissue region 566. For example, the first lumen region 561 or the second lumen region 562 may be the first label region.

The control unit 21 extracts the boundary line 53 of the first label region, using a known edge extraction algorithm (step S523). The center diagram on the right side of FIG. 4 illustrates a state in which the boundary line 53 is extracted. The control unit 21 selects a start point from among the pixels on the boundary line 53 (step S524). The control unit 21 creates a plurality of measurement lines 539 that go through only the first label region from the start point and reach other pixels on the boundary line 53 (step S525).

The control unit 21 selects the shortest measurement line 539 from among the plurality of measurement lines 539 created in step S525 (step S526). The control unit 21 determines whether the measurement line 539 selected in step S526 is shorter than the threshold value (step S527). The threshold value is, for example, five millimeters.

When determining that the measurement line 539 is shorter than the threshold value (YES in step S527), the control unit 21 records the thin-walled part flag in the pixels on the thin-walled part data 59 corresponding to the pixels through which the measurement line 539 passes, as described with reference to FIG. 6 (step S528).

When determining that the measurement line 539 is not shorter than the threshold value (NO in step S527), or after the end of step S528, the control unit 21 determines whether to end the creation of the measurement line 539 (step S529). For example, when all the pixels on the boundary line 53 have been selected as the start point in step S524, the control unit 21 chooses to end the process. The control unit 21 may choose to end the process when all the pixels selected at predetermined intervals on the boundary line 53 have been selected as the start point in step S524.

When determining not to end the process (NO in step S529), the control unit 21 returns to step S524. When determining to end the process (YES in step S529), the control unit 21 records the created thin-walled part data 59 in the auxiliary storage device 23 or the main storage device 22 (step S530). Thereafter, the control unit 21 ends the process.

According to the present embodiment, a learning model generation method that generates the classification model 31 configured to accurately classify a thinly drawn region in the tomographic image 58 can be provided. The classification model 31 generated according to the present embodiment enables to appropriately extract a living tissue having a small wall thickness, such as the fossa ovalis, the tricuspid valve, and the mitral valve, which are sites punctured with a puncture needle when atrial septal puncture is performed.

After machine learning is first performed by a normal approach that does not use the thin-walled part data 59, additional learning of the classification model 31 may be performed by the approach of the present embodiment. After machine learning is performed using training data different from the tomographic image 58 recorded in the classification training DB 41, the transfer learning may be performed by the approach of the present embodiment. This allows to generate the classification model 31 having good performance in a shorter time than a case where the thin-walled part data 59 is used from an initial stage of machine learning.

[Modification 1-1]

The present modification illustrates a modification of the calculation method for the difference data 55. In the present modification, the loss is weighted based on the distance between the i-th pixel and the image acquisition catheter 28. For example, the control unit 21 calculates losses relating to each label of each pixel, using formula (4) instead of formula (1).

$$\begin{matrix}[ Math . 4 ] & \\ {E}_{ij} = \{ \begin{matrix}\frac{- L n ( {Q}_{ij} )}{{R}_{i}} & ( Correct answer label ) \\ \frac{- L n ( 1 - {Q}_{ij} )}{{R}_{i}} & ( Incorrect answer label )\end{matrix} & ( 4 )\end{matrix}$$

Ri indicates the distance between the i-th pixel and the image acquisition catheter.

By using Eij calculated from formula (4) and formulas (2) and (3), the loss value 551 is defined such that the loss in the pixel falling under the thin-walled part region 569 has a greater influence than the loss in the pixel not falling under the thin-walled part region 569, and the loss in the pixel located at a place near the image acquisition catheter 28 has a greater influence than the loss in the pixel located at a place far from the image acquisition catheter 28.

Note that the weighting based on the distance between the i-th pixel and the image acquisition catheter 28 is not limited to formula (4). The denominator of formula (4) may be, for example, the square root of the distance Ri, the square of the distance Ri, or the like.

[Modification 1-2]

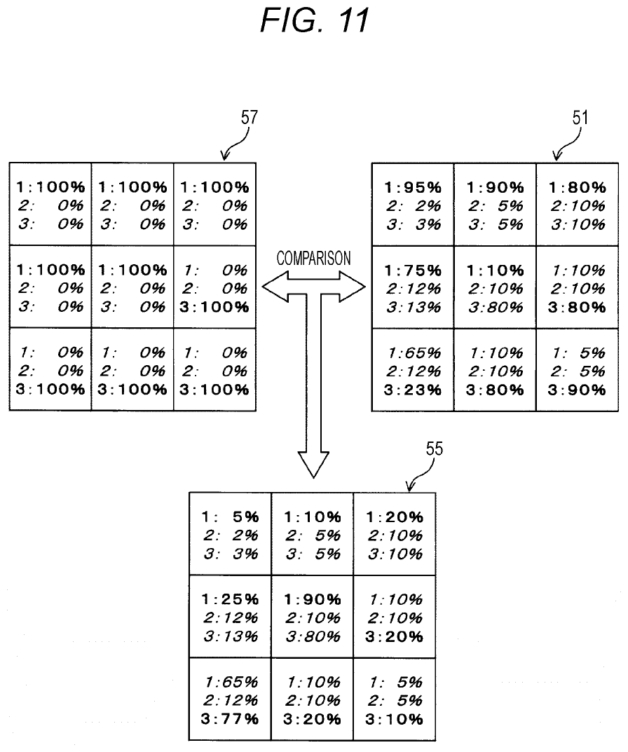

FIG. 11 is an explanatory diagram explaining a modification of the difference data 55. In the present modification, losses relating to each label of each pixel are calculated based on the absolute value of the difference between the correct answer classification data 57 and the output classification data 51.

FIG. 11 illustrates an example in which the absolute value of the difference between the correct answer classification data 57 and the output classification data 51 is recorded in each pixel of the difference data 55 for the probabilities that the pixel falls under each region. In the difference data 55 illustrated in FIG. 11, it is recorded that the upper right pixel has a difference of 20% for the first lumen region 561, a difference of 10% for the second lumen region 562, and a difference of 10% for the living tissue region 566.

Note that the square of the difference between the correct answer classification data 57 and the output classification data 51 may be recorded in each pixel of the difference data 55. When the square is used, the absolute value does not have to be calculated.

[Modification 1-3]

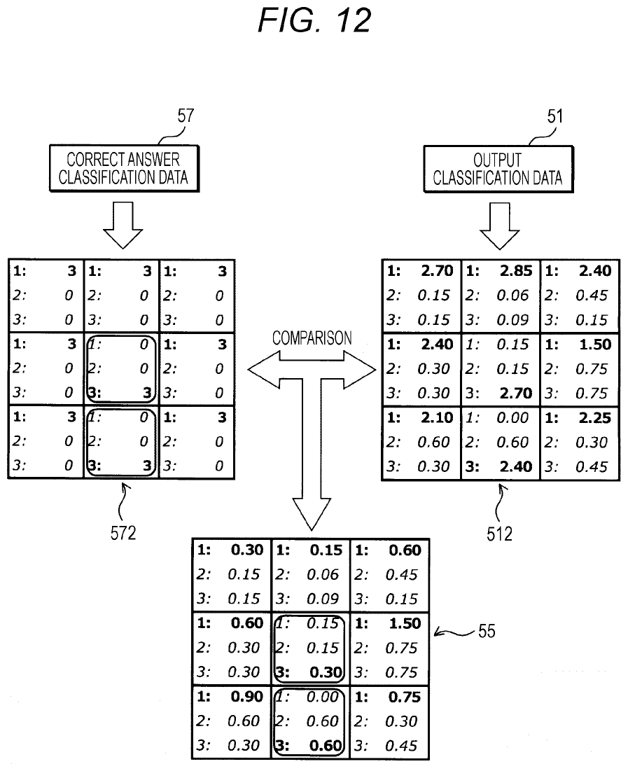

FIG. 12 is an explanatory diagram explaining a modification of the difference data 55. In the present modification, for the correct answer classification data 57 and the output classification data 51, simple numerical values are used instead of using the probabilities that the pixel falls under each region.

The control unit 21 multiplies each piece of data included in the correct answer classification data 57 by a constant to calculate second correct answer classification data 572. The control unit 21 multiplies each piece of data included in the output classification data 51 by a constant to calculate second output classification data 512.

FIG. 12 illustrates an example of a case where both of the correct answer classification data 57 and the output classification data 51 are multiplied by three to calculate the second correct answer classification data 572 and the second output classification data 512. In the second correct answer classification data 572 and the second output classification data 512, the sum of the values corresponding to each region is not one in every pixel, and thus the values are not numerical values indicating the probabilities that the pixel falls under each region.

In the example illustrated in FIG. 12, the absolute value of the difference between the second correct answer classification data 572 and the second output classification data 512 is recorded in each pixel of the difference data 55 for each region. Instead of formula (1), this absolute value is used as Eij indicating the loss relating to the j-th label of the i-th pixel. Then, the loss value 551 is calculated using Eij calculated in this manner and formulas (2) and (3). The control unit 21 performs parameter adjustment for the classification model 31 using, for example, the back propagation method such that the loss value 551 approaches a predetermined value. The predetermined value is a small value such as “0” or “0.1”. This adjusts the parameters of the classification model 31 such that the second output classification data 512 approaches the second correct answer classification data.

Note that the constant at the time of calculating the second correct answer classification data 572 and the constant at the time of calculating the second output classification data 512 may have different values. The classification model 31 may be configured to output the second output classification data 512 multiplied by a constant, instead of the output classification data 51. The correct answer classification data 57 may be recorded in the classification training DB 41 in a multiplied state by a constant.

The constant at the time of calculating the second correct answer classification data 572 and the constant at the time of calculating the second output classification data 512 may have different values for each pixel. Specifically, the constant is set such that a pixel having a closer distance from the image acquisition catheter 28 has a greater value. This defines the loss value 551 such that the loss at a place close to the image acquisition catheter 28 has a greater influence than the loss at a place far from the image acquisition catheter 28.

In addition, as in the second correct answer classification data 572, learning may be performed directly using correct answer classification data 57 created with a predetermined value such as “3” as the correct answer label and “O” as the incorrect answer label. In this case, the classification model 31 outputs the value of the label of each region as the output classification data 51 for each pixel. Then, instead of the difference data 55 illustrated in FIG. 12, difference data is calculated as the absolute value of the difference between the correct answer classification data 57 and the output classification data 51 for each region, and the loss value 551 is calculated and parameter adjustment is performed on the basis of this difference data.

This adjusts the parameters of the classification model 31 such that the output classification data 51 approaches the correct answer classification data 57. Note that, when the classification model 31 outputs the output classification data 51, machine learning of the classification model 31 can be efficiently carried out by setting the lower limit value for the label value of each region to “0” and matching the sum of the label values of the respective regions in one pixel with a predetermined value of the correct answer label or setting the upper limit value of the region label in one pixel to a predetermined value of the correct answer label.

[Modification 1-4]

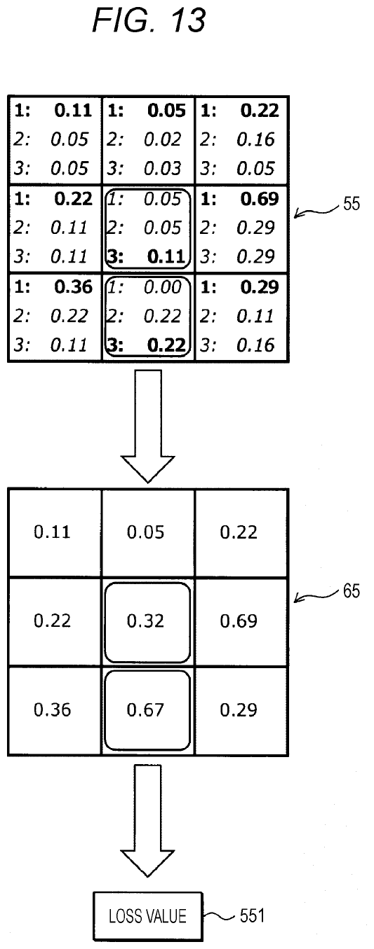

FIG. 13 is an explanatory diagram explaining a modification of the weighted difference data 65. In the present modification, the weighted difference data 65 is calculated based on only the data relating to the correct answer label without using the data relating to the incorrect answer label. The control unit 21 calculates the loss of each pixel based on, for example, formula (5) instead of formula (2).

[Math. 5]

Fi=EᵢₖGᵢ (5)

k indicates the number given to the correct answer region in the i-th pixel.

In the present modification, the loss Fi of the i-th pixel that is not classified into the thin-walled part region 569 is the loss of the correct answer label of the i-th pixel in the difference data 55. In the present modification, since the difference data 55 does not have to be calculated for the incorrect answer label, the control unit 21 is allowed to calculate the weighted difference data 65 with a small computation amount.

[Modification 1-5]

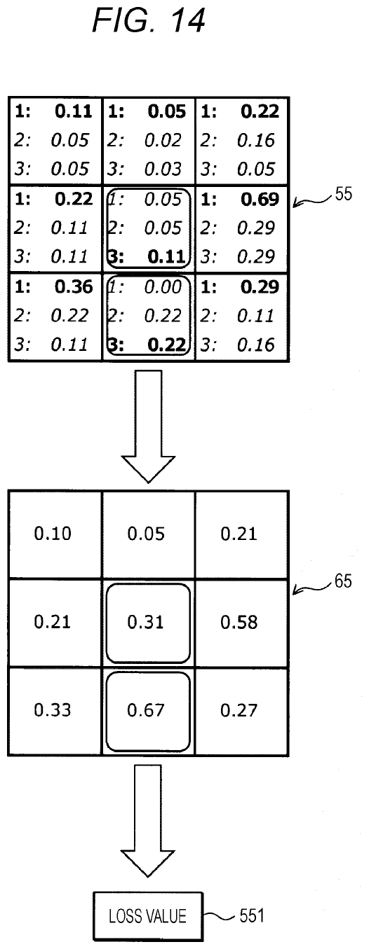

FIG. 14 is an explanatory diagram explaining a modification of the weighted difference data 65. In the present modification, the weighted difference data 65 is calculated based on only the data relating to the incorrect answer label without using the data relating to the correct answer label. The control unit 21 calculates the loss of each pixel based on, for example, formula (6) instead of formula (2).

$$\begin{matrix}[ Math . 6 ] & \\ F i = {\sum }_{j = 1}^{u} {E}_{ij} {G}_{i} {H}_{j} & ( 6 )\end{matrix}$$

Hj indicates whether the j-th label is the correct answer label or the incorrect answer label.

When the j-th label is the correct answer label, Hj=0 holds.

When the j-th label is the incorrect answer label, Hj=1 holds.

[Modification 1-6]

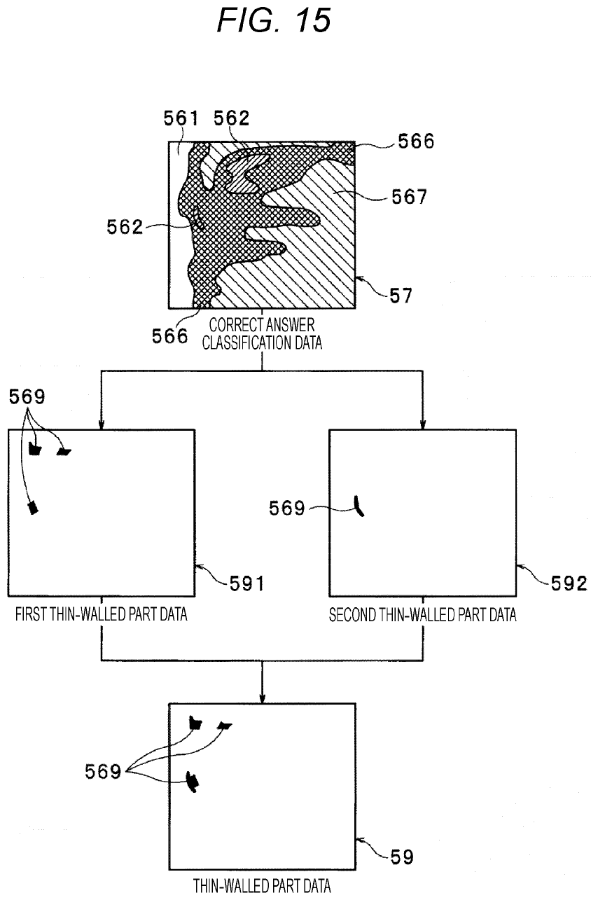

FIG. 15 is an explanatory diagram explaining a modification of the thin-walled part data 59. In FIG. 15, each diagram is illustrated in the RT format. First thin-walled part data 591 is data obtained by extracting the living tissue region 566 from the correct answer classification data 57 and then extracting the thin-walled part region 569. Second thin-walled part data 592 is data obtained by extracting the second lumen region 562 from the correct answer classification data 57 and then extracting the thin-walled part region 569. The thin-walled part data 59 includes both of the thin-walled part region 569 of the first thin-walled part data 591 and the thin-walled part region 569 of the second thin-walled part data 592.

According to the present modification, learning of the classification model 31 can be performed by weighting the thin-walled part region 569 for each of a plurality of types of regions. Therefore, a learning model generation method that generates the classification model 31 configured to accurately classify a thinly drawn region for each of a plurality of types of regions can be provided.

[Modification 1-7]

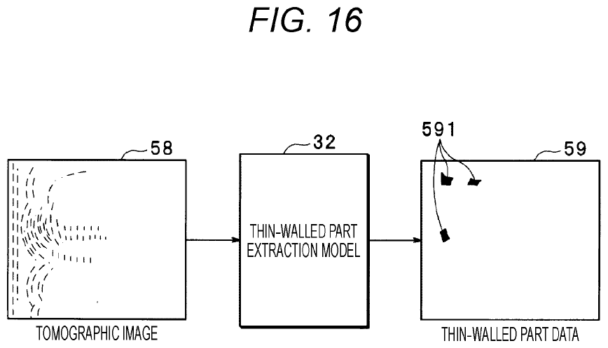

FIG. 16 is an explanatory diagram explaining a thin-walled part extraction model 32. The thin-walled part extraction model 32 is a model that receives an input of the tomographic image 58 and outputs the thin-walled part data 59.

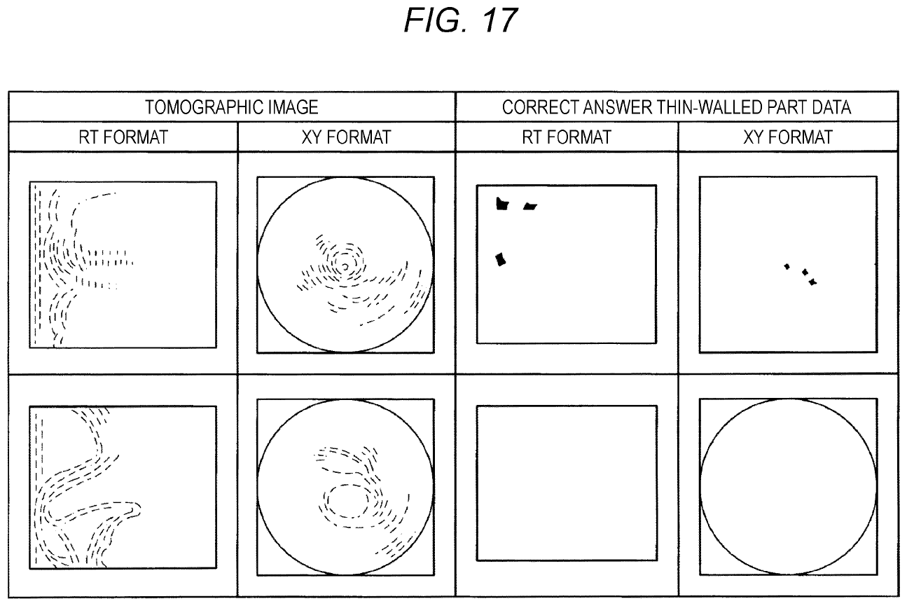

FIG. 17 is an explanatory diagram explaining a record layout of a thin-walled part training DB. The thin-walled part training DB is used for machine learning of the thin-walled part extraction model 32. The thin-walled part training DB includes a tomographic image field and a correct answer thin-walled part data field. Each of the tomographic image field and the correct answer thin-walled part data field has two subfields, namely, an RT format field and an XY format field.

The RT format field of the tomographic image field records the tomographic image 58 in the RT format formed by arranging scanning line data in parallel in the order of the scanning angle. The XY format field of the tomographic image field records the tomographic image 58 in the XY format generated by conducting coordinate transformation on the tomographic image 58 in the RT format.

The RT format field of the correct answer thin-walled part data field records the thin-walled part data 59 in the RT format. The XY format field of the correct answer thin-walled part data field records the thin-walled part data 59 in the XY format. The thin-walled part data 59 of the thin-walled part training DB is generated using, for example, the program described with reference to FIG. 9. Note that, in the lower records illustrated in FIG. 17, the thin-walled part region 569 is not detected.

Note that the tomographic image 58 in the XY format may be generated by coordinate transformation from the tomographic image 58 in the RT format if applicable, instead of being recorded in the thin-walled part training DB. Only one of the correct answer thin-walled part data in the RT format and the correct answer thin-walled part data in the XY format may be recorded in the thin-walled part training DB, and the other may be generated by coordinate transformation if applicable. The thin-walled part training DB has one record for one set of thin-walled part training data.

Returning to FIG. 16, the description will be continued. Machine learning of the thin-walled part extraction model 32 that outputs the thin-walled part data 59 when the tomographic image 58 is input is performed using the thin-walled part training DB. Here, the thin-walled part extraction model 32 is, for example, a model having a U-Net structure that implements semantic segmentation. The thin-walled part extraction model 32 may be a Mask R-CNN model or any other model that implements segmentation of an image.

An outline of a machine learning method will be described. One set of thin-walled part training data is acquired from the thin-walled part training DB. The tomographic image 58 is input to the thin-walled part extraction model 32 in the middle of learning, and the thin-walled part data 59 is output. The parameters of the thin-walled part extraction model 32 are adjusted such that the thin-walled part data 59 output from the thin-walled part extraction model 32 matches the thin-walled part data 59 recorded in the thin-walled part training data.

After the appropriate thin-walled part extraction model 32 is generated, the thin-walled part data 59 can be generated with a small computation amount by using the thin-walled part extraction model 32.

[Modification 1-8]

The present modification relates to a generation method for the classification model 31 that uses the thin-walled part data 59 as hint information. Description of parts common to the first embodiment will not be repeated.

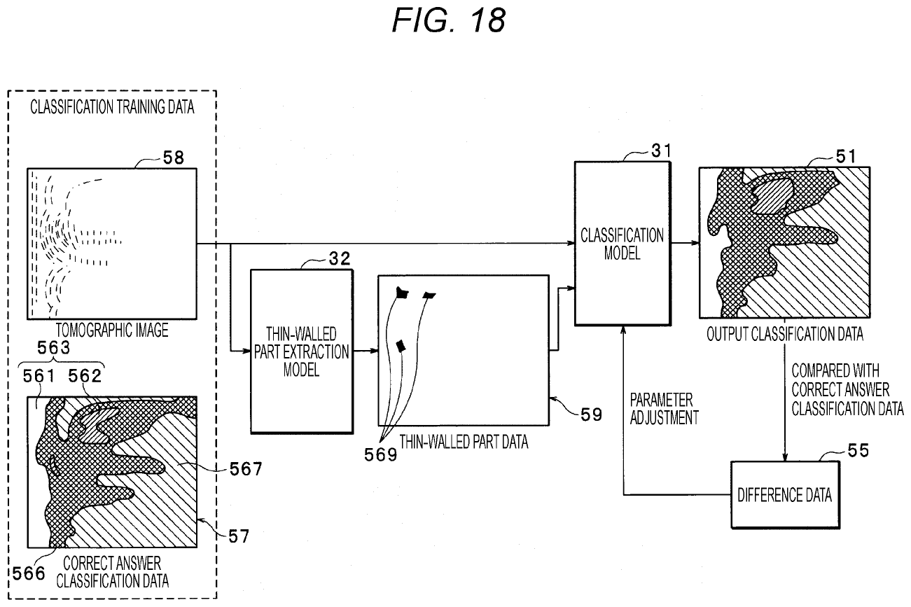

FIG. 18 is an explanatory diagram explaining a generation method for the classification model 31 according to a modification 1-8. Machine learning of the classification model 31 is performed using the classification training DB 41. Here, the classification model 31 is a model that receives inputs of the tomographic image 58 and the thin-walled part data 59 and uses the thin-walled part data 59 as the hint information having a high correct answer probability, to output the output classification data 51.

An outline of a machine learning method will be described. One set of classification training data is acquired from the classification training DB 41. The tomographic image 58 is input to the thin-walled part extraction model 32 described with reference to FIG. 15, and the thin-walled part data 59 is output. Note that the thin-walled part data 59 may be created by the program described with reference to FIG. 10.

The tomographic image 58 and the thin-walled part data 59 are input to the classification model 31, and the output classification data 51 is output. The difference data 55 is generated based on the comparison between the output classification data 51 and the correct answer classification data 57. The loss value 551 is defined based on the difference data 55. Parameter adjustment for the classification model 31 is performed using, for example, the back propagation method such that the loss value 551 approaches a predetermined value.

### Second Embodiment

The present embodiment relates to a machine learning method and the like that adjust the parameters of a classification model 31, using weighted correct answer classification data 66 obtained by weighting correct answer classification data 57 based on thin-walled part data 59. Description of parts common to the first embodiment will not be repeated.

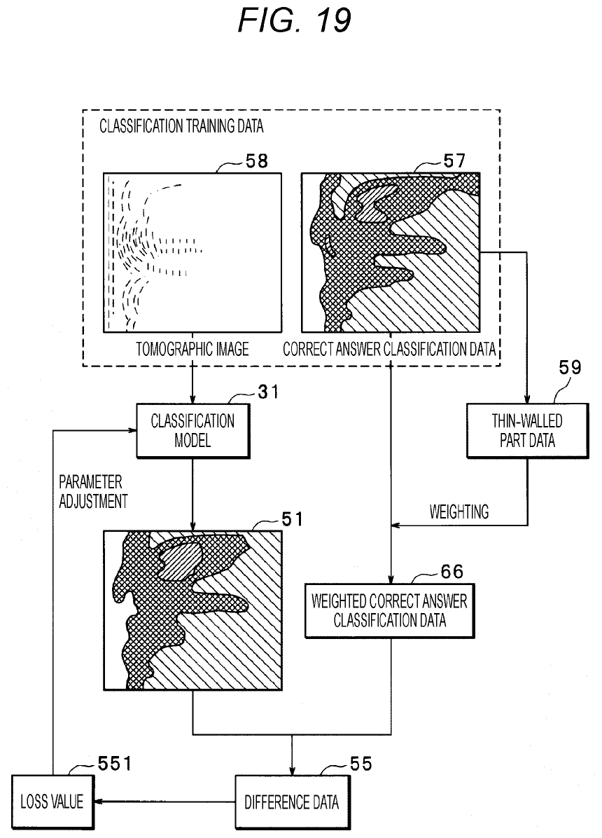

FIGS. 19 to 22 are explanatory diagrams explaining a generation method for the classification model 31 according to a second embodiment. Classification training data in which a tomographic image 58 and the correct answer classification data 57 are combined as a set is recorded in a classification training DB 41. Based on the correct answer classification data 57, a control unit 21 generates the thin-walled part data 59 obtained by extracting a thin-walled part region 569 thinner than a predetermined threshold value for a specified region.

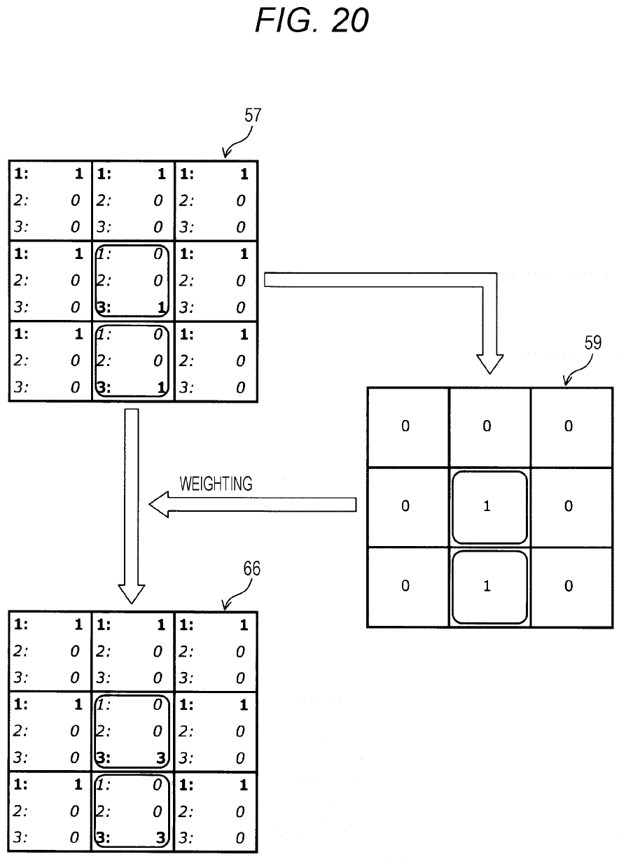

The control unit 21 generates the weighted correct answer classification data 66 obtained by weighting the portion of the thin-walled part region 569 in the correct answer classification data 57. A specific example of the weighted correct answer classification data 66 will be described with reference to FIG. 20.

The upper left part of FIG. 20 schematically illustrates nine pixels of the correct answer classification data 57. Note that the correct answer classification data 57 in FIG. 20 is the same data as the correct answer classification data 57 in FIG. 7 and is displayed using numerical values of “0” and “1” instead of the percentage display. The right part of FIG. 20 schematically illustrates the thin-walled part data 59.

The lower left part of FIG. 20 schematically illustrates the weighted correct answer classification data 66. In the following description, each piece of data constituting the weighted correct answer classification data 66 is also described as a “pixel” similarly to the data included in the tomographic image 58. Each group of the nine pixels illustrated in FIG. 20 indicates a group of pixels located at the corresponding place. The pixels in the center and the lower center on which the rounded rectangles are displayed are pixels corresponding to the thin-walled part region 569.

The control unit 21 calculates the weighted correct answer classification data 66 by formula (7).

$$\begin{matrix}[ Math . 7 ] & \\ D {w}_{ij} = \{ \begin{matrix}{D}_{ij} & ( Non - thin - walled part region ) \\ m \cdot {D}_{ij} & ( Thin - walled part region )\end{matrix} & ( 7 )\end{matrix}$$

Dij indicates correct answer data for the j-th label of the i-th pixel.

Dwij indicates weighted correct answer data for the j-th label of the i-th pixel.

m indicates a constant greater than one.

In the example illustrated in FIG. 20, the constant m is three. The data of the pixel corresponding to the thin-walled part region 569 has a value of three times the data of the other pixels. In the weighted correct answer classification data 66, the sum of the respective labels is m for the pixels in the thin-walled part region 569, and the sum of the respective labels is one for the pixels in a region other than the thin-walled part region 569.

Returning to FIG. 19, the description will be continued. The control unit 21 inputs the tomographic image 58 to the classification model 31 in the middle of learning and acquires output classification data 51. The control unit 21 generates difference data 55 based on the comparison between the output classification data 51 and the weighted correct answer classification data 66.

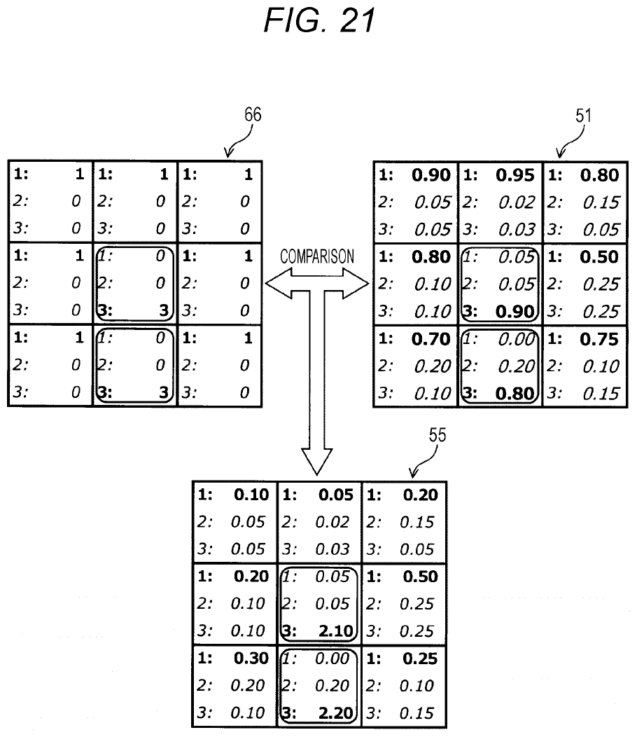

The upper left part of FIG. 21 schematically illustrates nine pixels of the weighted correct answer classification data 66. The upper right part of FIG. 21 schematically illustrates nine pixels of the output classification data 51. The lower part of FIG. 21 schematically illustrates nine pixels of the difference data 55. Each group of the nine pixels illustrated in FIG. 21 indicates a group of pixels located at the corresponding place. For the correct answer classification data 57 and the difference data 55, the pixels in the center and the lower center on which the rounded rectangles are displayed are pixels corresponding to the thin-walled part region 569.

The control unit 21 generates the difference data 55 in which losses relating to each label of each pixel are recorded, by formula (8).

[Math. 8]

Eᵢⱼ=|Dwᵢⱼ−Qᵢⱼ| (8)

Eij indicates the loss relating to the j-th label of the i-th pixel.

Qij indicates a probability that the i-th pixel has the j-th label in the output classification data.

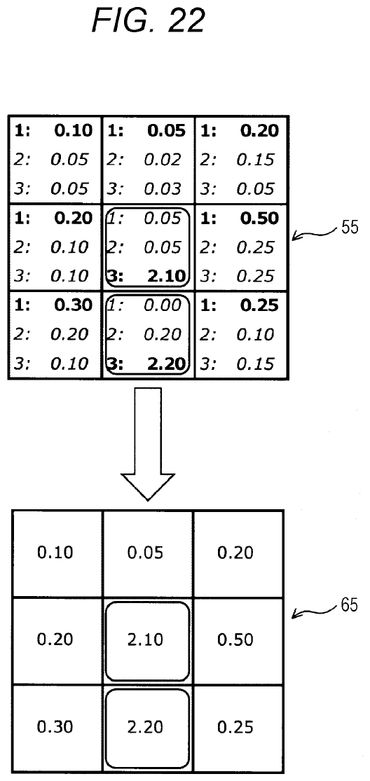

Returning to FIG. 19, the description will be continued. The control unit 21 calculates a representative value of respective pixels constituting the difference data 55 to generate weighted difference data 65. FIG. 22 illustrates the difference data 55 illustrated in the lower part of FIG. 21 and the weighted difference data 65 generated based on this difference data 55. In the example illustrated in FIG. 22, for each pixel of the difference data 55, the control unit 21 generates the weighted difference data 65, using the loss with respect to the correct answer label as the representative value. In this case, the control unit 21 does not have to calculate the loss corresponding to the incorrect answer label. The losses of the pixels corresponding to the thin-walled part region 569 surrounded by the rounded rectangles have obviously greater values than the losses of the pixels in a region other than the thin-walled part region 569.

The control unit 21 calculates the loss value 551, based on the weighted difference data 65. The control unit 21 performs parameter adjustment for the classification model 31 using, for example, the back propagation method such that the loss value 551 approaches a predetermined value. By machine learning in which parameter adjustment is repeated using a large number of pieces of the classification training data, the classification model 31 configured to accurately classify even a portion corresponding to the thin-walled part region 569 is generated.

[Modification 2-1]

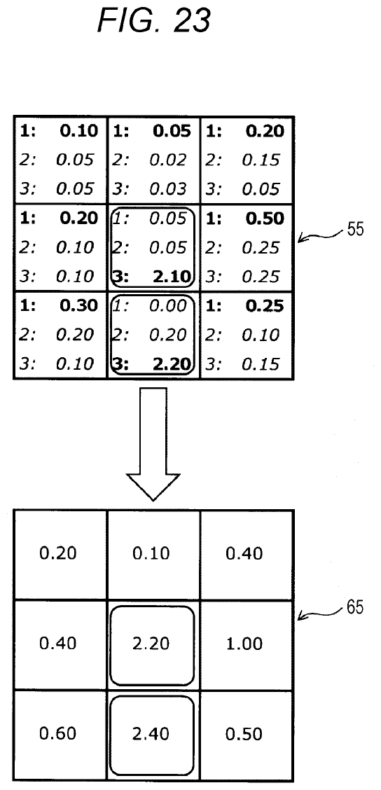

FIG. 23 is an explanatory diagram explaining the weighted correct answer classification data 66 according to a modification 2-1. In the present modification, for each pixel of the difference data 55, the control unit 21 generates the weighted difference data 65, using the total sum of losses with respect to all the labels as the representative value. Also in the present modification, the losses of the pixels corresponding to the thin-walled part region 569 surrounded by the rounded rectangles have obviously greater values than the losses of the pixels in a region other than the thin-walled part region 569.

According to the present embodiment, the loss value 551 can be calculated by simple addition and integration without using natural logarithms.

### Third Embodiment

The present embodiment relates to a generation method for a classification model 31 that defines a loss value 551 based on the distance between boundary lines 53 between a first lumen region 561 and a living tissue region 566. Description of parts common to the first embodiment will not be repeated.

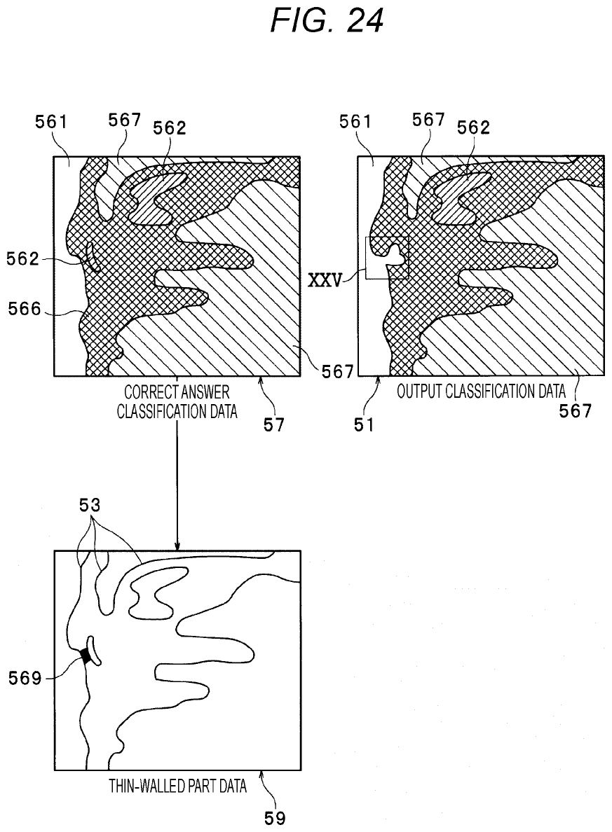

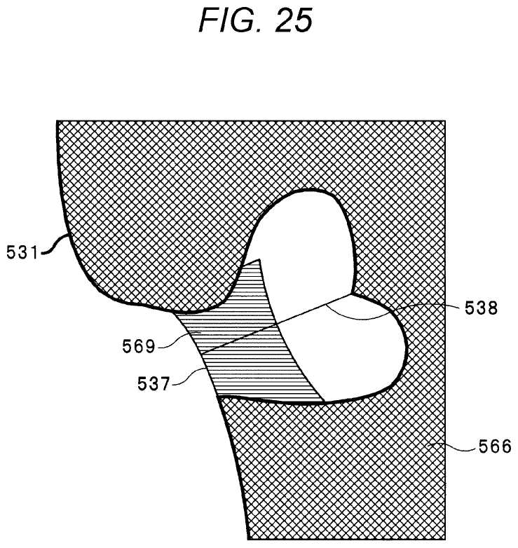

FIGS. 24 and 25 are explanatory diagrams explaining the loss value 551 according to a third embodiment. In FIG. 24, each diagram is illustrated in the RT format. The upper left part of FIG. 24 illustrates correct answer classification data 57 recorded in classification training data.

The lower left part of FIG. 24 illustrates a diagram in which the boundary lines 53 indicating edges of the living tissue region 566 are superimposed on the thin-walled part data 59 generated based on the correct answer classification data 57.

The living tissue region 566 at a portion sandwiched between the first lumen region 561 located at the left end of the correct answer classification data 57 and a vertically long second lumen region 562 forms a thin-walled part region 569.

The upper right part of FIG. 24 illustrates output classification data 51 output from the classification model 31 when a tomographic image 58 recorded in the classification training data is input to the classification model 31 being trained. When the correct answer classification data 57 is compared with the output classification data 51, the vicinity of the thin-walled part region 569 is not accurately classified.

FIG. 25 is a diagram in which the XXV portion of the output classification data 51 is enlarged and the thin-walled part region 569 indicated by thin horizontal line hatching is superimposed. An output boundary line 531 that is a boundary between the living tissue region 566 and the first lumen region 561 in the output classification data 51 is indicated by a thick line. A correct answer boundary line 537 that is a boundary between the living tissue region 566 and the first lumen region 561 in the correct answer classification data 57 is indicated by a solid line. In the state illustrated in FIG. 24, learning of the classification model 31 has progressed to such an extent that the correct answer boundary line 537 substantially matches the output boundary line 531 except in the vicinity of the thin-walled part region 569.

The control unit 21 generates a determination line 538 connecting each pixel on the output boundary line 531 and the correct answer boundary line 537 at the shortest distance. In the following description, the end part of the determination line 538 on the side of the output boundary line 531 will be described as a start point, and the end part of the determination line 538 on the side of the correct answer boundary line 537 will be described as an end point.

The control unit 21 calculates the length of the determination line 538. The length of the determination line 538 indicates the distance between the correct answer boundary line 537 and the output boundary line 531 and corresponds to the loss of each pixel on the output boundary line 531. The control unit 21 calculates the loss value 551 such that a pixel whose end point of the determination line 538 is in contact with the thin-walled part region 569 has a stronger influence than a pixel whose end point of the determination line 538 is not in contact with the thin-walled part region 569. A specific example will be given and described.

The control unit 21 calculates the loss value 551 based on, for example, formula (9).

$$\begin{matrix}[ Math . 9 ] & \\ Loss value = \frac{1}{P} {\sum }_{i = 1}^{P} ( Li \cdot Gi ) & ( 9 )\end{matrix}$$

Li indicates the length of the determination line 538 whose start point is the i-th pixel.

Gi indicates a weight relating to the thin-walled part region.

When the end point of the determination line whose start point is the i-th pixel is not in the thin-walled part region, Gi=1 holds.

When the end point of the determination line whose start point is the i-th pixel is in the thin-walled part region, Gi=m holds.

P indicates the number of pixels on the output boundary line.

m indicates a constant greater than one.

Formula (9) indicates that the loss value 551 is defined such that the contact of the end point of the determination line 538 with the thin-walled part has a weight of m times with respect to the non-contact with the thin-walled part. The constant m is, for example, 100.

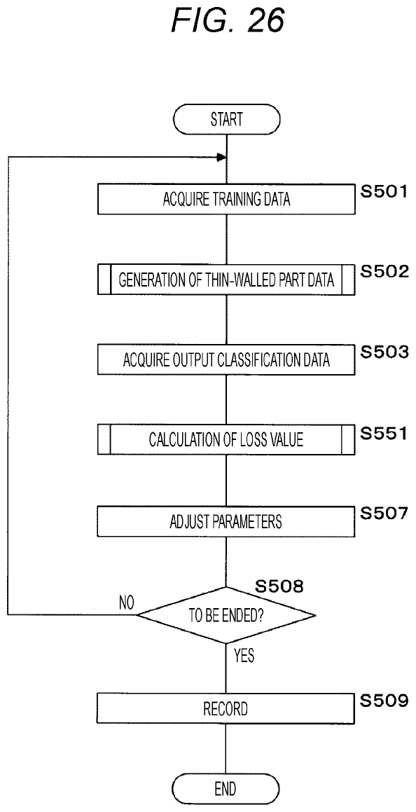

FIG. 26 is a flowchart explaining a processing flow of a program according to the third embodiment. Since the processes from step S501 to step S503 are the same as the processes of the program according to the first embodiment described with reference to FIG. 9, the description thereof will not be repeated.

The control unit 21 activates a subroutine for loss value calculation (step S551). The subroutine for loss value calculation is a subroutine that calculates the loss value 551 based on formula (9). The processing flow of the subroutine for loss value calculation will be described later.

The control unit 21 performs parameter adjustment for the classification model 31 using, for example, the back propagation method such that the loss value 551 approaches a predetermined value (step S507). Since the subsequent processing flow is the same as the processing flow of the program according to the first embodiment described with reference to FIG. 9, the description thereof will not be repeated.

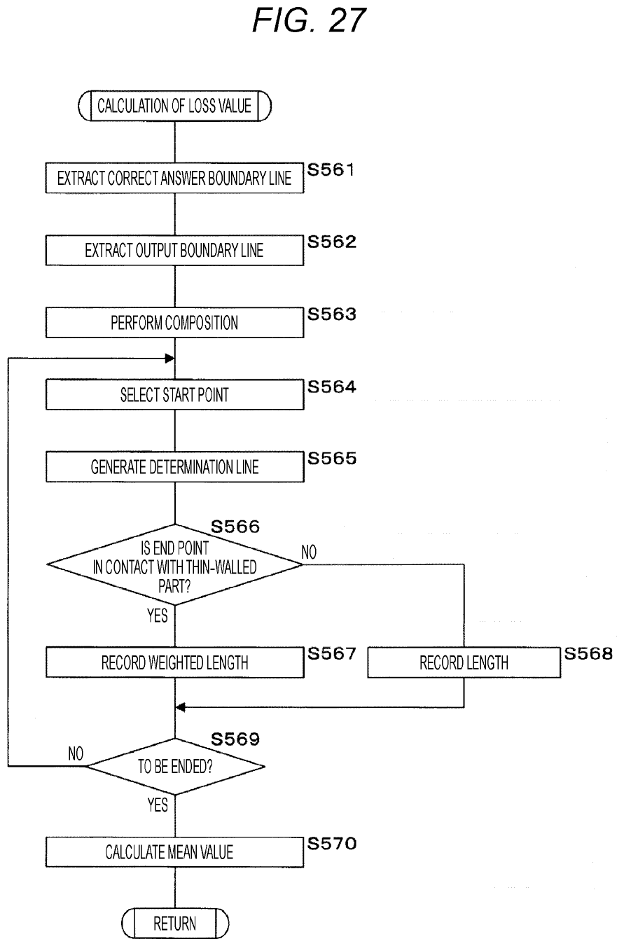

FIG. 27 is a flowchart explaining a processing flow of the subroutine for loss value calculation. The subroutine for loss value calculation is a subroutine that calculates the loss value 551 based on formula (9).

The control unit 21 extracts the correct answer boundary line 537 from the correct answer classification data 57 (step S561). The control unit 21 extracts the output boundary line 531 from the output classification data 51 (step S562). The control unit 21 generates a composite image in which the correct answer boundary line 537 and the output boundary line 531 are placed in one image (step S563). The control unit 21 executes the subsequent processes using the composite image.

The control unit 21 selects the start point from among the pixels on the output boundary line 531 (step S564). The control unit 21 generates the determination line 538 connecting the start point selected in step S563 and the correct answer boundary line 537 at the shortest distance (step S565). The control unit 21 determines whether the end point of the determination line 538 is in contact with the thin-walled part region 569 (step S566).

When determining that the determination line 538 is in contact with the thin-walled part region 569 (YES in step S566), the control unit 21 records a value obtained by weighting the length of the determination line 538 (step S567). When determining that the determination line 538 is not in contact with the thin-walled part region 569 (NO in step S566), the control unit 21 records the length of the determination line 538 (step S568).

After step S567 or S568 ends, the control unit 21 determines whether the process for all the pixels on the output boundary line 531 has ended (step S569). When determining that the process has not ended (NO in step S569), the control unit 21 returns to step S564.

When determining that the process has ended (YES in step S569), the control unit 21 calculates a mean value of the values recorded in steps S567 and S568 (step S570). The mean value calculated in step S570 is the loss value 551. Thereafter, the control unit 21 ends the process.

Note that the output boundary line 531 with which the control unit 21 calculates the loss value 551 is not limited to the boundary line 53 between the first lumen region 561 and the living tissue region 566. Machine learning of the classification model 31 can be performed based on the loss value 551 for the boundary line 53 between any regions.

In step S570, the control unit 21 may calculate a representative value such as a median value or a mode value instead of the mean value. In step S570, the control unit 21 may calculate a geometric mean value or a harmonic mean value instead of the arithmetic mean value indicated by formula (4). In the subroutine for loss value calculation, the control unit 21 may set the start points at predetermined intervals instead of sequentially setting the start points at all the pixels on the output boundary line 531.

According to the present embodiment, machine learning of the classification model 31 can be performed such that the entire shape of the output boundary line 531 approaches the correct answer boundary line 537. For example, after machine learning of the classification model 31 is performed by a normal approach that does not use the thin-walled part data 59 or the approach of the first embodiment, additional learning may be performed by the approach of the present embodiment.

### Fourth Embodiment

The present embodiment relates to a generation method for a classification model 31 that calculates a loss value 551 based on whether correct answer classification data 57 matches output classification data 51. Description of parts common to the first embodiment will not be repeated.

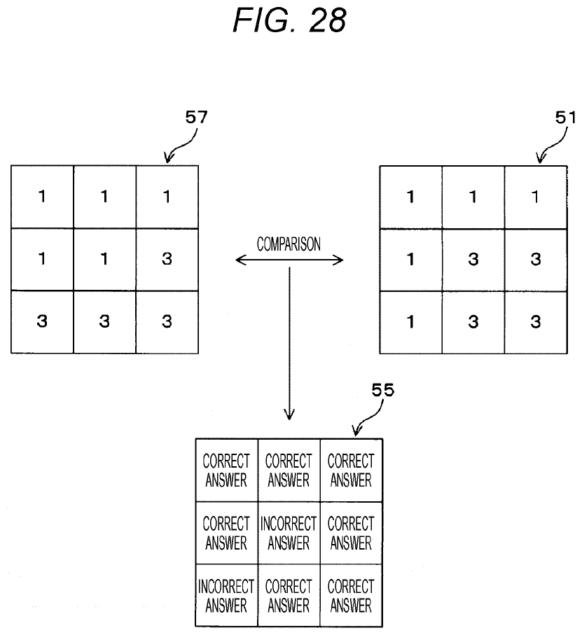

FIG. 28 is an explanatory diagram explaining difference data 55 according to a fourth embodiment. The upper left part of FIG. 28 schematically illustrates nine pixels of the correct answer classification data 57. The upper right part of FIG. 28 schematically illustrates nine pixels of the output classification data 51. The lower part of FIG. 28 schematically illustrates nine pixels of the difference data 55. The positions of the groups of the nine pixels illustrated in FIG. 28 correspond to each other.

Note that, in FIG. 28, one label representing the correct answer is recorded in each pixel of the correct answer classification data 57, and one label with the highest probability is recorded in each pixel of the output classification data 51. When the labels of the corresponding pixels of the correct answer classification data 57 and the output classification data 51 match with each other, the control unit 21 records a label indicating the “correct answer” in the corresponding pixel of the difference data 55 and, when the labels do not match with each other, records a label indicating the “incorrect answer”.

The control unit 21 calculates the loss value 551 such that the discrepancy between the “correct answer” and the “incorrect answer” in the pixel included in the thin-walled part region 569 has a stronger influence than the discrepancy between the “correct answer” and the “incorrect answer” in the pixel in a region other than the thin-walled part region 569. A specific example will be given and described.

The control unit 21 calculates the loss value 551 based on, for example, formula (10).

$$\begin{matrix}[ Math . 10 ] & \\ Loss value = \frac{1}{C} {\sum }_{i = 1}^{C} ( Fi \cdot Gi ) & ( 10 )\end{matrix}$$

Fi indicates the loss of the i-th pixel.

When the i-th pixel has the “incorrect answer”, Fi=k holds.

When the i-th pixel has the “correct answer”, Fi=0 holds.

Gi indicates a weight relating to the thin-walled part region.

When the i-th pixel falls under the thin-walled part region, Gi=m holds.

When the i-th pixel does not fall under the thin-walled part region, Gi=1 holds.

C indicates the number of pixels.

k indicates a constant that is a positive value.

m indicates a constant greater than one.

Formula (10) indicates that the loss value 551 is defined such that the incorrect answer given to the pixel in the thin-walled part region 569 has a weight of m times with respect to the incorrect answer given to the pixel in a region other than the thin-walled part region 569. The constant m is, for example, 100.

This will be described more specifically. When the number of pixels located in the thin-walled part region 569 is A and the number of pixels located in a region other than the thin-walled part region 569 is B among the pixels having the “incorrect answer”, the loss value 551 has a value indicated by formula (11).

$$\begin{matrix}[ Math . 11 ] & \\ Loss value = \frac{k}{C} ( m A + B ) & ( 11 )\end{matrix}$$

The control unit 21 defines a combination of parameters of the classification model 31 such that the loss value 551 approaches a predetermined value, using an approach such as the grid search, random search, or Bayesian optimization. By repeating parameter adjustment for the classification model 31 using a large number of pieces of classification training data, the control unit 21 performs machine learning of the classification model 31 such that the classification model 31 outputs the appropriate output classification data 51 when a tomographic image 58 is input.

According to the present embodiment, the classification model 31 can be generated using an algorithm different from the back propagation method.

### Fifth Embodiment

The present embodiment relates to a machine learning method and the like in which a threshold value for determining a thin-walled part region 569 is set to be greater at an initial stage of learning of a classification model 31 and the threshold value is reduced as learning progresses. Description of parts common to the first embodiment will not be repeated.

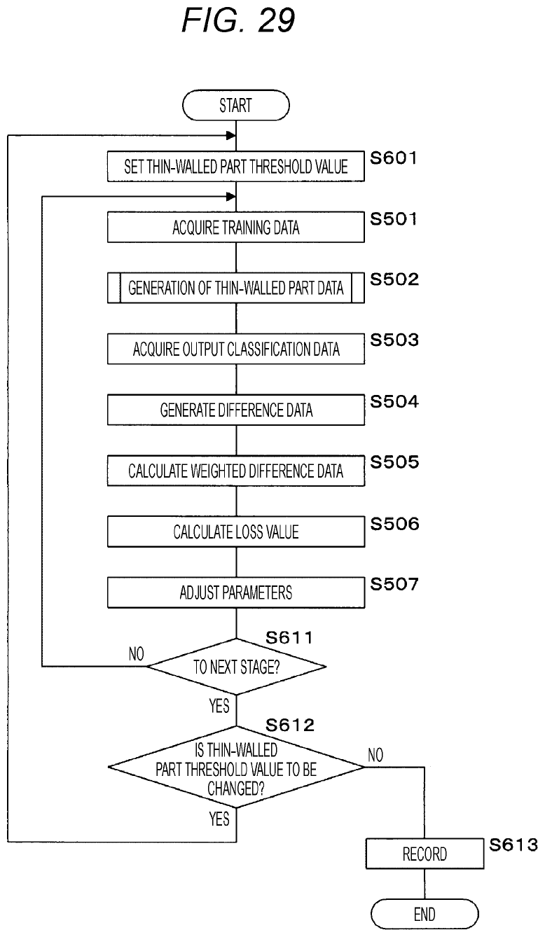

FIG. 29 is a flowchart explaining a processing flow of a program according to a fifth embodiment. A control unit 21 sets the threshold value for determining the thin-walled part region 569, which is used when generating thin-walled part data 59 based on correct answer classification data 57, to a predetermined value (step S601).

The control unit 21 acquires one set of classification training data from a classification training DB 41 (step S501). Since the subsequent processes up to step S507 are the same as the processes of the program according to the first embodiment described with reference to FIG. 9, the description thereof will not be repeated.

The control unit 21 determines whether to shift to the next stage (step S611). For example, when a predetermined number of pieces of the classification training data have been learned, the control unit 21 determines to shift to the next stage. For example, when the loss value 551 or the amount of adjustment of the parameters falls below a predetermined threshold value, the control unit 21 may determine to shift to the next stage.

When determining not to shift to the next stage (NO in step S611), the control unit 21 returns to step S501. When determining to shift to the next stage (YES in step S611), the control unit 21 determines whether to change the threshold value for determining the thin-walled part region 569 (step S612). For example, when the threshold value has reached a predetermined minimum value, the control unit 21 determines not to change the threshold value.

When determining to change the threshold value (YES in step S612), the control unit 21 returns to step S601 and sets the threshold value to a value smaller than the value in the previous loop. When determining not to change the threshold value (NO in step S612), the control unit 21 records the adjusted parameters of the classification model 31 in an auxiliary storage device 23 (step S613). Thereafter, the control unit 21 ends the process. As described above, the generation of the classification model 31 ends.

A specific example will be given and described. In an initial stage of machine learning, a threshold value for determining first thin-walled part data 591 is set to about five millimeters. As the machine learning progresses, the threshold value is gradually reduced and finally, is set to a target value of about one millimeter. By setting in this manner, the parameters of the classification model 31 can be efficiently adjusted.

According to the present embodiment, machine learning of the classification model 31 can be efficiently carried out.

### Sixth Embodiment

The present embodiment relates to a catheter system 10 that generates a three-dimensional image in real time, using a three-dimensional scanning image acquisition catheter 28. Description of parts common to the first embodiment will not be repeated.

FIG. 30 is an explanatory diagram explaining a configuration of a catheter system 10 according to a sixth embodiment. The catheter system 10 includes an image processing apparatus 230, a catheter control device 27, a motor driving unit (MDU) 289, and an image acquisition catheter 28. The image acquisition catheter 28 is connected to the image processing apparatus 230 via the MDU 289 and the catheter control device 27.

The image acquisition catheter 28 includes a sheath 281, a shaft 283 introduced through the inside of the sheath 281, and a sensor 282 disposed at a distal end of the shaft 283. The MDU 289 rotates and advances and retracts the shaft 283 and the sensor 282 inside the sheath 281.

The catheter control device 27 generates one tomographic image 58 for each rotation of the sensor 282. By the operation on the MDU 289 to rotate the sensor 282 while pulling or pushing the sensor 282, the catheter control device 27 continuously generates a plurality of tomographic images 58 substantially perpendicular to the sheath 281.

The image processing apparatus 230 includes a control unit 231, a main storage device 232, an auxiliary storage device 233, a communication unit 234, a display unit 235, an input unit 236, and a bus. The control unit 231 is an arithmetic control device that executes a program of the present embodiment. For the control unit 231, one or a plurality of CPUs or GPUs, a multi-core CPU, or the like is used. The control unit 231 is connected to each hardware unit constituting the image processing apparatus 230 via the bus.

The main storage device 232 is a storage device such as an SRAM, a DRAM, or a flash memory. In the main storage device 232, information involved in the middle of the process performed by the control unit 231 and the program being executed by the control unit 231 are temporarily saved.

The auxiliary storage device 233 is a storage device such as an SRAM, a flash memory, a hard disk, or a magnetic tape. In the auxiliary storage device 233, the classification model 31 described with reference to the first to fourth embodiments, a program to be executed by the control unit 231, and various sorts of data involved in executing the program are saved. The classification model 31 is an example of a trained model of the present embodiment.

The communication unit 234 is an interface that performs communication between the image processing apparatus 230 and a network. The classification model 31 may be stored in an external mass storage device or the like connected to the image processing apparatus 230.

For example, the display unit 235 is a liquid crystal display panel, an organic EL panel, or the like. For example, the input unit 236 is a keyboard, a mouse, or the like. The input unit 236 may be stacked on the display unit 235 to constitute a touch panel. The display unit 235 may be a display device connected to the image processing apparatus 230.

The image processing apparatus 230 is dedicated hardware used in combination with the catheter control device 27, for example. The image processing apparatus 230 and the catheter control device 27 may be integrally configured. The image processing apparatus 230 may be a general-purpose personal computer, a tablet, a large computing machine, or a virtual machine that works on a large computing machine. The image processing apparatus 230 may be constituted by a plurality of personal computers that perform distributed processing, or hardware such as a large computing machine. The image processing apparatus 230 may be constituted by a cloud computing system or a quantum computer.

The control unit 231 successively acquires the tomographic images 58 from the catheter control device 27. The control unit 231 inputs each tomographic image 58 to the classification model 31 and acquires output classification data 51 that has been output. The control unit 21 generates a three-dimensional image based on a plurality of pieces of the output classification data 51 acquired in time series and outputs the generated three-dimensional image to the display unit 235. As described above, so-called three-dimensional scanning is performed.

The advancing and retracting operation of the sensor 282 includes both of an operation of advancing and retracting the entire image acquisition catheter 28 and an operation of advancing and retracting the sensor 282 inside the sheath 281. The advancing and retracting operation may be automatically performed at a predetermined speed by the MDU 289 or may be manually performed by the user.

Note that the image acquisition catheter 28 is not limited to a mechanical scanning mechanism that mechanically performs rotation and advancement and retraction. For example, the image acquisition catheter 28 may be an electronic radial scanning image acquisition catheter 28 using the sensor 282 in which a plurality of ultrasound transducers is annularly disposed. Instead of the image acquisition catheter 28, a transesophageal echocardiography (TEE) probe or an extracorporeal ultrasound probe may be used.

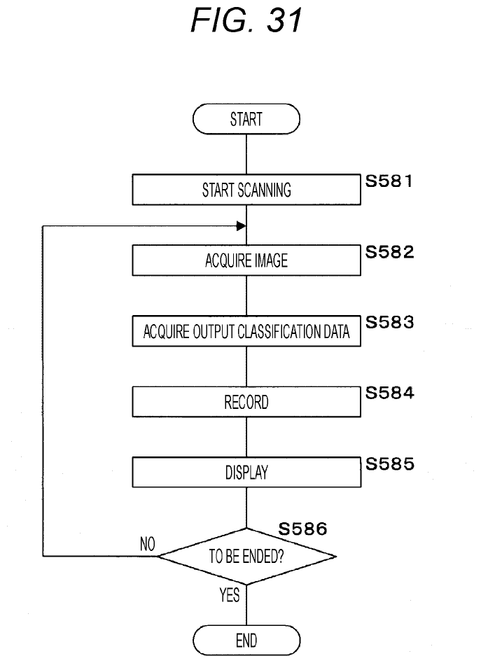

FIG. 31 is a flowchart explaining a processing flow of a program according to the sixth embodiment. When receiving an instruction to start three-dimensional scanning from the user, the control unit 231 executes a program to be described with reference to FIG. 31.

The control unit 231 instructs the catheter control device 27 to start three-dimensional scanning (step S581). The catheter control device 27 controls the MDU 289 to start three-dimensional scanning. The control unit 231 acquires one tomographic image 58 from the catheter control device 27 (step S582). In step S582, the control unit 231 implements the function of an image acquisition unit of the present embodiments.

The control unit 231 inputs the tomographic image 58 to the classification model 31 and acquires the output classification data 51 that has been output (step S583). In step S583, the control unit 231 implements the function of a classification data acquisition unit of the present embodiments. The control unit 231 records the output classification data 51 in the auxiliary storage device 233 or the communication unit 234 (step S584).

The control unit 231 displays the three-dimensional image generated based on the output classification data 51 recorded in time series, on the display unit 235 (step S585). The control unit 231 determines whether to end the process (step S586). For example, when a series of three-dimensional scanning has ended, the control unit 231 determines to end the process.

When determining not to end the process (NO in step S586), the control unit 231 returns to step S582. When determining to end the process (YES in step S586), the control unit 231 ends the process.

According to the present embodiment, the catheter system 10 equipped with the classification model 31 described in the first to fourth embodiments can be provided. According to the present embodiment, the catheter system 10 that displays an appropriate segmentation result even when a thin portion exists in the site to be scanned can be provided.

According to the present embodiment, since segmentation can be performed appropriately, the catheter system 10 that displays a three-dimensional image with less noise can be provided. Furthermore, the catheter system 10 configured to appropriately perform automatic measurement of the area, the volume, and the like can be provided.

### Seventh Embodiment

The present embodiment relates to a mode that implements an information processing apparatus 20 of the present embodiment by causing a general-purpose computer 90 and a program 97 to work in combination. Description of parts common to the first embodiment will not be repeated.

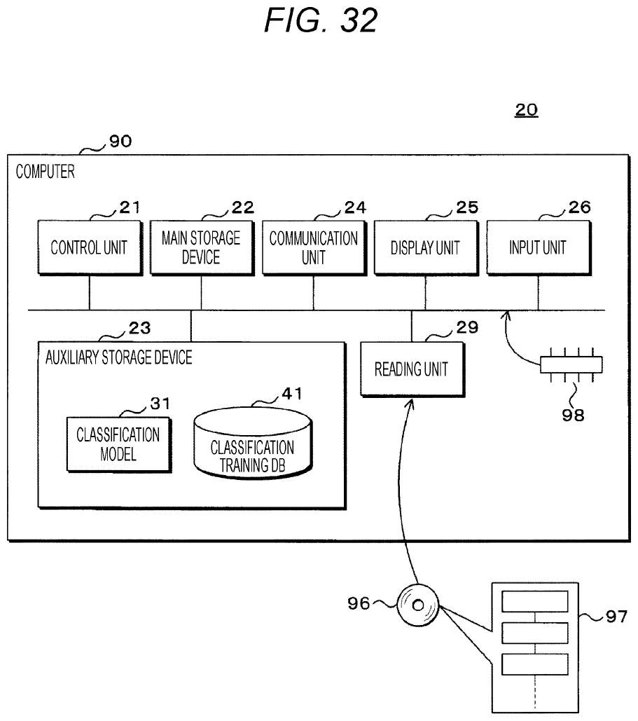

FIG. 32 is an explanatory diagram explaining a configuration of the information processing apparatus 20 according to a seventh embodiment. The computer 90 includes a control unit 21, a main storage device 22, an auxiliary storage device 23, a communication unit 24, a display unit 25, an input unit 26, a reading unit 29, and a bus. The computer 90 is a general-purpose personal computer, a tablet, a smartphone, a large computing machine, a virtual machine working on a large computing machine, a cloud computing system, or a quantum computer. The computer 90 may be made up of a plurality of personal computers or the like that performs distributed processing.

The program 97 is recorded in a portable recording medium 96. The control unit 21 reads the program 97 via the reading unit 29 and saves the read program 97 in the auxiliary storage device 23. In addition, the control unit 21 may read the program 97 stored in a semiconductor memory 98 such as a flash memory mounted in the computer 90. Furthermore, the control unit 21 may download the program 97 from another server computer (not illustrated) connected via the communication unit 24 and a network (not illustrated) and save the downloaded program 97 in the auxiliary storage device 23.

The program 97 is installed as a control program for the computer 90 and is loaded into the main storage device 22 to be executed. This causes the computer 90 to function as the information processing apparatus 20 described above. The program 97 is an example of a program product.

### Eighth Embodiment

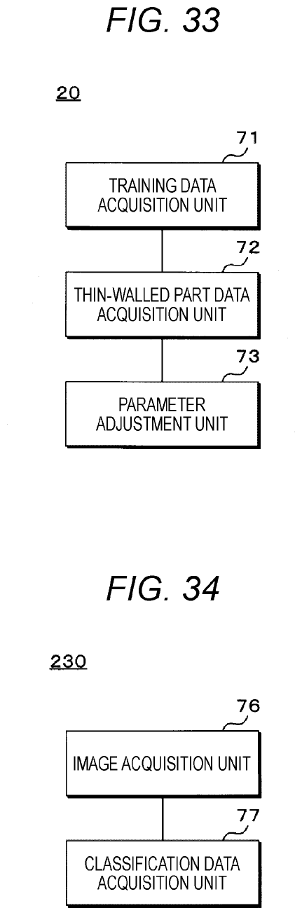

FIG. 33 is a functional block diagram of an information processing apparatus 20 according to an eighth embodiment. The information processing apparatus 20 includes a training data acquisition unit 71, a thin-walled part data acquisition unit 72, and a parameter adjustment unit 73.

The training data acquisition unit 71 acquires training data from a training database 41 that records a plurality of sets of a tomographic image 58 acquired using a tomographic image acquisition probe 28, and correct answer classification data 57 in which each pixel included in the tomographic image 58 is classified into a plurality of regions including a living tissue region 566 and a non-living tissue region, in association with each other.

The thin-walled part data acquisition unit 72 acquires thin-walled part data 59 relating to a range of a thin-walled part thinner than a predetermined threshold value for a predetermined region in the correct answer classification data 57. The parameter adjustment unit 73 performs a parameter adjustment process for a learning model 31 that outputs output classification data 51 obtained by classifying each pixel included in the tomographic image 58 into the plurality of regions, based on the training data and the thin-walled part data 59.

### Ninth Embodiment

FIG. 34 is a functional block diagram of an image processing apparatus 230 according to a ninth embodiment. The image processing apparatus 230 includes an image acquisition unit 76 and a classification data acquisition unit 77.

The classification data acquisition unit 77 acquires a tomographic image 58 obtained using a tomographic image acquisition probe 28. The classification data acquisition unit 77 inputs the tomographic image 58 to a trained model 31 generated by the above-described method and acquires output classification data 51.

The technical features (components) described in each embodiment can be combined with each other, and new technical features can be formed by the combination.

It is supposed that the embodiments disclosed herein are considered to be an example in all respects and not to be restrictive. The scope of the present invention is indicated not by the above meaning but by the claims and is intended to include all changes within the meaning and scope equivalent to the claims.

1.-20. (canceled)

21. A learning model generation method comprising:
acquiring training data from a training database that records a plurality of sets of a tomographic image acquired using a tomographic image acquisition probe, and correct answer classification data in which pixels in the tomographic image are classified into a plurality of regions including a living tissue region and a non-living tissue region, in association with each other;
acquiring thin-walled part data relating to a thin-walled part thinner than a predetermined threshold value, for a predetermined region in the correct answer classification data; and
performing a parameter adjustment process for a learning model that outputs output classification data in which the pixels in the tomographic image are classified into the plurality of regions, based on the training data and the thin-walled part data.

22. The learning model generation method according to claim 21, wherein the parameter adjustment process includes:
inputting the tomographic image and the thin-walled part data into the learning model and acquiring the output classification data that has been output by the parameter adjustment process; and
adjusting a parameter of the learning model such that a calculated value calculated from a function relating to a difference between the correct answer classification data and the output classification data approaches a predetermined value.

23. The learning model generation method according to claim 21, wherein the parameter adjustment process includes:
inputting the tomographic image into the learning model and acquiring output classification data that has been output by the parameter adjustment process; and
adjusting a parameter of the learning model such that a calculated value calculated from a function relating to a difference between the output classification data and weighted correct answer classification data obtained by adding a weight to a portion of the correct answer classification data related to the thin-walled part recorded in the thin-walled part data approaches a predetermined value.

24. The learning model generation method according to claim 21, wherein the parameter adjustment process includes:
inputting the tomographic image into the learning model and acquiring output classification data that has been output by the parameter adjustment process;
acquiring difference data relating to a difference between the correct answer classification data and the output classification data; and
adjusting a parameter of the learning model such that a calculated value calculated by weighting a portion of the difference data related to the thin-walled part recorded in the thin-walled part data approaches a predetermined value.

25. The learning model generation method according to claim 24, wherein
the output classification data is data that records which of the regions the pixels included in the tomographic image are classified, and
the difference data is data obtained by determining whether a classification recorded in the output classification data matches a classification recorded in the correct answer classification data, for the pixels included in the tomographic image.

26. The learning model generation method according to claim 24, wherein
the output classification data is data that records probabilities that the pixels included in the tomographic image are classified into the plurality of regions, and
the difference data is data obtained by calculating a difference between the probabilities recorded in the output classification data for the pixels included in the tomographic image and target values determined from the classification recorded in the correct answer classification data.

27. The learning model generation method according to claim 24, wherein the difference data is data relating to a distance between boundary lines between predetermined two regions in the output classification data and the correct answer classification data.

28. The learning model generation method according to claim 21, wherein the thin-walled part data is generated based on the correct answer classification data.

29. The learning model generation method according to claim 21, wherein the thin-walled part data is recorded in the training data in association with the tomographic image and the correct answer classification data.

30. The learning model generation method according to claim 21, wherein the thin-walled part data is acquired by inputting the tomographic image into a thin-walled part extraction model that outputs the thin-walled part data when the tomographic image is input into the learning model.

31. The learning model generation method according to claim 21, wherein the thin-walled part is a portion in which the living tissue region is displayed to be thinner than the predetermined threshold value.

32. The learning model generation method according to claim 21, wherein the thin-walled part is a portion in which a lumen region circumferentially surrounded by the living tissue region is displayed to be thinner than the predetermined threshold value.

33. The learning model generation method according to claim 21, wherein the thin-walled part is a portion displayed to be thinner than the predetermined threshold value the plurality of regions.

34. The learning model generation method according to claim 21, wherein the predetermined threshold value is received via an input.

35. The learning model generation method according to claim 21, wherein the threshold value is a thickness of the thin-walled part in an XY format image obtained by displaying the correct answer classification data in an XY format.

36. The learning model generation method according to claim 21, wherein the threshold value is a thickness of the thin-walled part in an RT format image obtained by displaying the correct answer classification data in an RT format.

37. The learning model generation method according to claim 21, wherein the tomographic image acquisition probe is an image acquisition catheter configured to be inserted into a body of a patient.

38. An image processing apparatus comprising:
an image acquisition unit configured to acquire a tomographic image obtained using a tomographic image acquisition probe; and
a classification data acquisition unit configured to input the tomographic image into a trained model generated by a learning model generation method according to claim 21, and to acquire the output classification data.

39. A non-transitory computer-readable medium configured to store a program for causing a computer to execute a process comprising:
acquiring the tomographic image obtained using the tomographic image acquisition probe;
inputting the tomographic image into the trained model generated by the learning model generation method according to claim 21; and
acquiring the output classification data.

40. A training data generation method comprising:
acquiring a tomographic image acquired using a tomographic image acquisition probe;
acquiring correct answer classification data in which the tomographic image is classified into a plurality of regions including a living tissue region and a non-living tissue region;
generating thin-walled part data relating to a range of a thin-walled part in which a predetermined region is thinner than a predetermined threshold value, from the correct answer classification data; and
recording a plurality of sets of the tomographic image, the correct answer classification data, and the thin-walled part data in association with each other.
